(19) United States
(12) Patent Application Publication
(10) Pub. No.: US 2022/0023950 A1
(43) Pub. Date: Jan. 27, 2022

(54) ADDITIVE MANUFACTURING DEVICE

(71) Applicant: JTEKT CORPORATION, Osaka-shi (JP)

(72) Inventors: Takaya NAGAHAMA, Obu-shi (JP); Makoto TANO, Obu-shi (JP); Koichi SHIIBA, Nisshin-shi (JP)

(73) Assignee: JTEKT CORPORATION, Osaka-shi (JP)

(21) Appl. No.: 17/311,050

(22) PCT Filed: Dec. 6, 2019
(86) PCT No.: PCT/JP2019/047814

§ 371 Date: Jun. 4, 2021

(51) Int. Cl. B22F 10/366; B22F 10/20; B22F 12/13; B22F 12/53; B22F 12/45; B22F 12/55; B22F 12/00; B33Y 40/10; B33Y 30/00

(52) U.S. Cl. CPC B22F 10/366; B22F 10/20; B22F 12/13; B22F 12/53; B22F 12/45; B22F 1/0059; B22F 12/226; B22F 12/224; B33Y 40/10; B33Y 30/00; B22F 12/55

(57) ABSTRACT

An additive manufacturing device that forms a shaped object on a base by using one material of a powdery material and a linear material includes an additive material supply unit, a light irradiation unit, and a control unit that controls supply of the one material, irradiation with a light beam, and relative movement of the light beam. The light irradiation unit includes a central light beam irradiation part and an outer-side light beam irradiation part. The control unit separately controls an output condition of the central light beam irradiation part and an output condition of the outer-side light beam irradiation part, and the control unit increases a peak in a distribution shape of power density of the central light beam to be larger than a peak in a distribution shape of power density of the outer-side light beam to form the shaped object.

### TECHNICAL FIELD

The present disclosure relates to an additive manufacturing device.

### BACKGROUND ART

As described in JP2015-196265A, a laser metal deposition (LIVID) method applied to an additive manufacturing device is used as a build-up technique (partial control processing of physical properties) in which powder materials of the same kind or different kinds of metals are injected and supplied to a metal base and are irradiated with laser light to melt, and then the powder materials are solidified to add a shaped object to the base. With the LMD method, a component ratio of a plurality of powder materials can be adjusted to supply the plurality of power materials, which is difficult to perform with a selective laser melting (SLM) method, and as compared with the SLM method, a higher shape freedom degree is presented and high-speed shaping of about 5 times to 10 times as high as that of the SLM method is possible.

With the LMD method, for example, when a hard shaped object made of tungsten carbide (WC) or the like is added to a base made of carbon steel (S45C), sputtering may occur at the time of rapid heating, and cracking may occur at the time of rapid solidification, and quality of the hard shaped object deteriorates.

In addition, with the LMD method, for example, when adding a shaped object made of copper (Cu) to a base made of an iron-based material, it is difficult to stably add the shaped object made of copper to the base made of carbon steel due to a difference in laser absorptance (thermal conductivity) between iron and copper.

### SUMMARY OF INVENTION

The present disclosure provides an additive manufacturing device capable of adding a high-quality shaped object, and an additive manufacturing device capable of stably adding a shaped object.

(1. Mode of Additive Manufacturing Device)

According to an aspect of an additive manufacturing device of the present invention, the additive manufacturing device configured to form a shaped object on a base by using one material of a powdery material and a linear material includes: an additive material supply unit configured to supply the one material to the base; a light irradiation unit configured to irradiate a supply portion on the base with a light beam, the supply portion being a portion to which the one material is supplied; and a control unit configured to control a supply of the one material by the additive material supply unit, an irradiation with a light beam by the light irradiation unit, and a relative movement of the light beam to the base.

The light irradiation unit includes a central light beam irradiation part that irradiates a central portion of the supply portion of the one material with a central light beam and an outer-side light beam irradiation part that irradiates an outer side of the central light beam with an outer-side light beam. The light beam includes the central light beam and the outer-side light beam. The control unit is configured to control an output condition of the central light beam irradiation part and an output condition of the outer-side light beam irradiation part separately. The central light beam has a power density related to the output condition of the central light beam irradiation part. The outer-side light beam has a power density related to the output condition of the outer-side light beam irradiation part. The control unit is configured to increase a peak in a distribution shape of the power density of the central light beam to be larger than a peak in a distribution shape of the power density of the outer-side light beam to form the shaped object.

According to the aspect of the present invention, since preheat processing can be performed as pre-processing of addition processing of the shaped object with the outer-side light beam, it is not necessary to greatly increase the peak in a laser beam profile of the power density of the central light beam. Accordingly, rapid heating by the central light beam can be reduced, and occurrence of sputtering can be suppressed. In addition, since temperature-maintaining processing can be performed as post-processing of the addition processing of the shaped object with the outer-side light beam, rapid solidification of the shaped object can be suppressed, and occurrence of cracking can be prevented. Therefore, a high-quality shaped object can be added to the base.

(2. Another Mode of Additive Manufacturing Device)

According to another aspect of an additive manufacturing device of the present invention, the additive manufacturing device configured to form a shaped object on a base by using a plurality of kinds of powdery materials includes: an additive material supply unit including a component ratio adjustment unit that adjusts a component ratio of the plurality of kinds of powdery materials, and configured to supply an adjusted powdery material to the base in an injection manner, the adjusted powdery material being a material to which the component ratio adjustment unit has adjusted the component ratio; a light irradiation unit configured to irradiate a supply portion on the base with a light beam, the supply portion being a portion to which the adjusted powdery material is supplied; and a control unit configured to control a supply of the adjusted powdery material by the additive material supply unit, an irradiation with a light beam by the light irradiation unit, and a relative movement of the light beam to the base.

The light irradiation unit includes a central light beam irradiation part that irradiates a central portion of the supply portion of the adjusted powdery material with a central light beam and an outer-side light beam irradiation part that irradiates an outer side of the central light beam with an outer-side light beam, and the light beam includes the central light beam and the outer-side light beam.

The control unit is configured to control an output condition of the central light beam irradiation part and an output condition of the outer-side light beam irradiation part separately in accordance with a change in the component ratio, when forming, on a surface of the base, an intermediate shaped object in which the component ratio gradually changes in a thickness direction.

According to the above another aspect of the present invention, a difference in thermal expansion coefficient between a peripheral surface of the base and the intermediate shaped object can be formed to gradually decrease toward a boundary between the peripheral surface of the base and the intermediate shaped object. A difference in thermal expansion coefficient between the intermediate shaped object and the shaped object can be formed to gradually decrease toward a boundary between an intermediate shaped object FC and a shaped object FF. Accordingly, by adding the intermediate shaped object FC to a base B and adding the shaped object FF to the intermediate shaped object FC, occurrence of cracking due to the difference in thermal expansion coefficient can be significantly suppressed.

(3. Another Mode of Additive Manufacturing Device)

According to another aspect of an additive manufacturing device of the present invention, the additive manufacturing device configured to form a shaped object on a base by using a powdery material includes: an additive material supply unit configured to supply the powdery material to the base in an injection manner; a light irradiation unit configured to irradiate a supply portion on the base with a light beam, the supply portion being a portion to which the powdery material is supplied; and a control unit configured to control a supply of the powdery material by the additive material supply unit, an irradiation with a light beam by the light irradiation unit, and a relative movement of the light beam to the base.

The light irradiation unit includes a central light beam irradiation part that irradiates a central portion of the supply portion of the powdery material with a central light beam and an outer-side light beam irradiation part that irradiates an outer side of the central light beam with an outer-side light beam. The light beam includes the central light beam and the outer-side light beam. The control unit is configured to control an output condition of the central light beam irradiation part and an output condition of the outer-side light beam irradiation part separately in accordance with a light beam absorptance of the powdery material. The central light beam has a power density related to the output condition of the central light beam irradiation part. The outer-side light beam has a power density related to the output condition of the outer-side light beam irradiation part. The control unit is configured to adjust a peak in a distribution shape of the power density of the central light beam and a peak in a distribution shape of the power density of the outer-side light beam to form the shaped object.

Accordingly, even when light beam absorptance of a powder material is high, rapid heating can be prevented to suppress occurrence of sputtering. In addition, even when the light beam absorptance of the powder material is low, it is possible to increase a temperature to improve the light beam absorptance proportional to the temperature. Then, a total laser output of the central light beam and the outer-side light beam can be maintained, and high-speed addition of the shaped object is possible.

### BRIEF DESCRIPTION OF DRAWINGS

FIG. 1 is a schematic diagram of an additive manufacturing device according to first and second embodiments of the present disclosure.

FIG. 2A is a perspective view illustrating a base to which a shaped object is to be added by the additive manufacturing device of FIG. 1.

FIG. 2B is a view of the base of FIG. 2A to which the shaped object is added, as viewed from a central axis direction.

FIG. 3A is a graph illustrating a relationship between a power density and a laser light irradiation range in a first stage (initial preheat processing of a circumferential surface of a base) in a case where a shaped object is to be added to the base by the additive manufacturing device of FIG. 1.

FIG. 3B is a graph illustrating a relationship between a power density and a laser light irradiation range in a second stage (addition processing of a shaped object) in a case where the shaped object is added to the base by the additive manufacturing device of FIG. 1.

FIG. 4A is a cross-sectional view illustrating an initial state of a shaped object added to a base at the time when the shaped object is added by the additive manufacturing device according to the first embodiment.

FIG. 4B is a cross-sectional view illustrating an intermediate state and an added state of the shaped object added to the base at the time when scanning proceeds from the state of FIG. 4A.

FIG. 5 is a flowchart illustrating an operation of the additive manufacturing device according to the first embodiment.

FIG. 6A is a first diagram illustrating each scanning state of a light beam in an operation of the additive manufacturing device according to the second embodiment.

FIG. 6B is a second diagram illustrating each scanning state of the light beam in the operation of the additive manufacturing device according to the second embodiment.

FIG. 6C is a third diagram illustrating each scanning state of the light beam in the operation of the additive manufacturing device according to the second embodiment.

FIG. 7 is a graph illustrating a temperature change of a portion J on a circumferential surface of the base in the states of FIGS. 6A to 6C.

FIG. 8 is a schematic diagram of an additive manufacturing device according to third and fourth embodiments of the present disclosure.

FIG. 9 corresponds to FIG. 2B, and is a view of a base to which a shaped object is added by the additive manufacturing device according to the third and fourth embodiments, as viewed from a central axis direction.

FIG. 10A is a graph illustrating a relationship between a power density and a laser light irradiation range in a first stage (initial preheat processing of a circumferential surface of a base) in a case where a shaped object is to be added to the base by the additive manufacturing device of FIG. 8 in the third embodiment.

FIG. 10B is a graph illustrating a relationship between the power density and the laser light irradiation range in a second stage (addition processing of an intermediate shaped object) in a case where the shaped object is added to the base by the additive manufacturing device of FIG. 8 in the third embodiment.

FIG. 10C is a graph illustrating a relationship between the power density and the laser light irradiation range in a third stage (addition processing of the shaped object) in a case where the shaped object is added to the base by the additive manufacturing device of FIG. 8 in the third embodiment.

FIG. 11A is a cross-sectional view illustrating an initial state of a shaped object added to an intermediate shaped object FC at the time when the shaped object is added by the additive manufacturing device according to the third embodiment.

FIG. 11B is a cross-sectional view illustrating an intermediate state and an added state of the shaped object added to the intermediate shaped object FC at the time when scanning proceeds from the state of FIG. 11A.

FIG. 12 is a flowchart illustrating an operation of the additive manufacturing device according to the third embodiment.

FIG. 13 is a flowchart illustrating the operation of the additive manufacturing device according to the fourth embodiment.

FIG. 14A is a graph illustrating a relationship between a power density and a laser light irradiation range in a first stage (preheat processing of a circumferential surface of a base) in which a shaped object is to be added by the additive manufacturing device according to the fourth embodiment.

FIG. 14B is a graph illustrating a relationship between the power density and the laser light irradiation range in an initial phase of a second stage (addition processing of an intermediate shaped object) in which the shaped object is added by the additive manufacturing device according to the fourth embodiment.

FIG. 14C is a graph illustrating a relationship between the power density and the laser light irradiation range in a middle phase of the second stage (addition processing of the intermediate shaped object) in which the shaped object is added by the additive manufacturing device according to the fourth embodiment.

FIG. 14D is a graph illustrating a relationship between the power density and the laser light irradiation range in an end phase of the second stage (addition processing of the intermediate shaped object) in which the shaped object is added by the additive manufacturing device according to the fourth embodiment.

FIG. 14E is a graph illustrating a relationship between the power density and the laser light irradiation range in an initial phase of a third stage (addition processing of an upper shaped object) in which the shaped object is added by the additive manufacturing device according to the fourth embodiment.

FIG. 14F is a graph illustrating a relationship between the power density and the laser light irradiation range in an end phase of the third stage (addition processing of the upper shaped object) in which the shaped object is added by the additive manufacturing device according to the fourth embodiment.

FIG. 15A is a cross-sectional view illustrating an initial state of an intermediate shaped object added to the base when adding an upper shaped object by the additive manufacturing device according to the fourth embodiment.

FIG. 15B is a cross-sectional view illustrating an intermediate state of the intermediate shaped object added to the base and an added state of the upper shaped object added to the base at the time when scanning proceeds from the state of FIG. 15A.

FIG. 16 is a schematic diagram illustrating another embodiment of a light irradiation unit of an additive manufacturing device.

### DESCRIPTION OF EMBODIMENTS

### 1. First Embodiment

(1-1. Outline of Additive Manufacturing Device)

An outline of an additive manufacturing device according to a first embodiment of the present disclosure will be described. The additive manufacturing device according to the first embodiment adds a shaped object to a base by using one kind of powder material with the LMD method. The powder material and the base may be different kinds of materials, or may be the same kind of material.

In this example, a case where a shaped object made of a powder material of tungsten carbide (WC) (hereinafter, referred to as a first powder material) is added to a base B made of carbon steel (S45C) will be described. Note that, in addition to the first powder material, a powder material (hereinafter, referred to as a binding powder material) such as nickel (Ni) or cobalt (Co) serving as a binder for the first powder material is also used in the additive manufacturing.

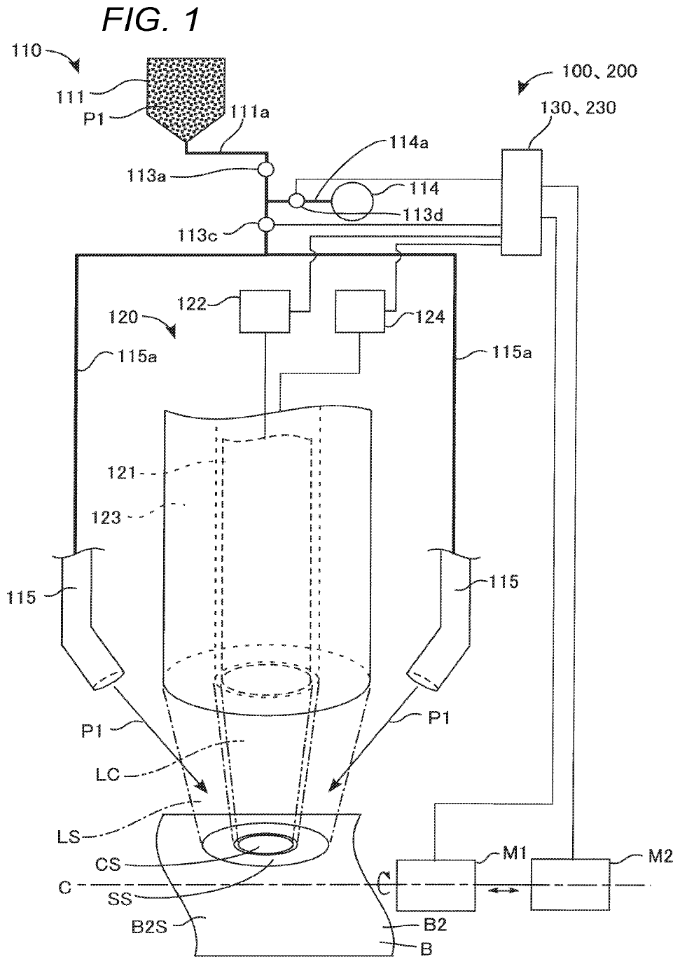

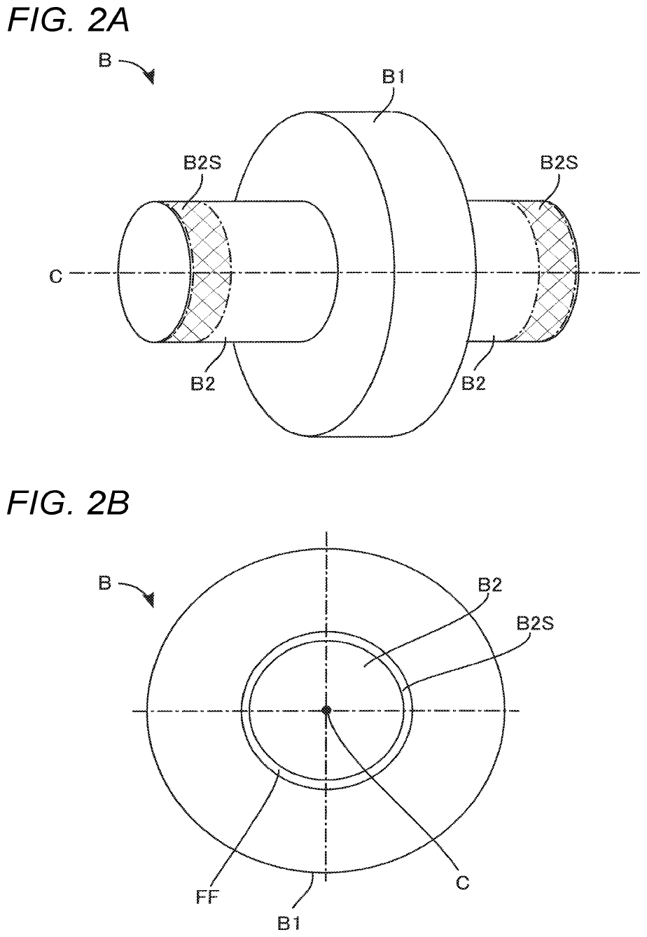

As illustrated in FIG. 1, an additive manufacturing device 100 includes an additive material supply unit 110, a light irradiation unit 120, a control unit 130, and the like. Here, a case will be described where the additive manufacturing device 100 adds a shaped object FF to circumferential surfaces (support portions of bearings (not illustrated)) B2S and B2S indicated by mesh lines on an open end side of cylindrical members B2 and B2 in a base B having a shape in which small-diameter cylindrical members B2 and B2 are coaxially integrated with both side surfaces of a large-diameter disk member B1 as illustrated in FIG. 2A.

At the time of additive manufacturing, as illustrated in FIG. 1, the additive manufacturing device 100 rotates the base B about a central axis C by a motor M1 and moves the base B in a direction of the central axis C by a motor M2. Accordingly, the shaped object can be added to the entire circumferential surfaces B2S and B2S on the open end side of the cylindrical members B2 and B2. The shaped object has a single-layer structure of the shaped object FF (see FIG. 2B), and details will be described later.

The additive material supply unit 110 illustrated in FIG. 1 includes a first hopper 111, a gas cylinder 114, and an injection nozzle 115. The first hopper 111 stores a first powder material P1 mixed with a binding powder material. In this example, since the shaped object FF is made of a large amount of the first powder material P1 and a small amount of the binding powder material, the amount of the binding powder material mixed with the first powder material P1 is set to an amount corresponding to the amount of the binding powder material in the shaped object FF.

A powder introduction valve 113a is connected to the first hopper 111 by a pipe 111a. A powder supply valve 113c is connected to the injection nozzle 115 by a pipe 115a. A gas introduction valve 113d is connected to the gas cylinder 114 by a pipe 114a.

The injection nozzle 115 injects and supplies the first powder material P1 to the circumferential surface B2S of the cylindrical member B2 of the base B by, for example, high-pressure nitrogen supplied from the gas cylinder 114. In this example, a case where two injection nozzles 115 are arranged at an interval of 180 degrees is exemplified, and alternatively a configuration may be adopted in which one injection nozzle is provided or three or more injection nozzles arranged at an equal angular interval are provided. The gas for supplying the first powder material P1 is not limited to nitrogen, and may be an inert gas such as argon.

The light irradiation unit 120 includes a central light beam irradiation part 121, a central light beam light source 122, an outer-side light beam irradiation part 123, and an outer-side light beam light source 124. The light irradiation unit 120 irradiates the circumferential surface B2S (supply portion of the first powder material P1) of the cylindrical member B2 of the base B with a central light beam LC from the central light beam light source 122 through the central light beam irradiation part 121, and irradiates the circumferential surface B2S with an outer-side light beam LS from the outer-side light beam light source 124 through the outer-side light beam irradiation part 123.

In this example, the central light beam irradiation part 121 radiates the central light beam LC having a circular irradiation shape (central light irradiation range CS). In addition, the outer-side light beam irradiation part 123 radiates the outer-side light beam LS having a ring-shaped irradiation shape (outer-side light irradiation range SS) surrounding an outer periphery of the central light beam LC. The central light beam LC plays a role in adding the shaped object FF to the circumferential surface B2S of the cylindrical member B2 of the base B. A role of the outer-side light beam LS will be described later. Although laser light is used as the central light beam LC and the outer-side light beam LS, the central light beam LC and the outer-side light beam LS are not limited to laser light, and may be, for example, electron beams as long as they are electromagnetic waves.

The control unit 130 controls powder supply of the additive material supply unit 110 and light irradiation of the light irradiation unit 120, and controls relative scanning performed with the central light beam LC and the outer-side light beam LS with respect to the circumferential surface B2S of the cylindrical member B2 of the base B. That is, the control unit 130 controls opening and closing of the powder supply valve 113c and the gas introduction valve 113d to control injection and supply of the first powder material P1 from the injection nozzle 115.

Further, the control unit 130 controls operations of the central light beam light source 122 and the outer-side light beam light source 124, respectively, and separately controls respective output conditions of the central light beam LC and the outer-side light beam LS, that is, respective laser outputs of the central light beam LC and the outer-side light beam LS and distribution shapes (laser beam profiles) of the laser outputs (power densities) per unit area of the central light irradiation range CS and the outer-side light irradiation range SS.

Further, the control unit 130 controls rotation of the motor M1 to rotate the base B about the central axis C, and controls rotation of the motor M2 to move the base B in the direction of the central axis C, thereby controlling the relative scanning performed with the central light beam LC and the outer-side light beam LS with respect to the circumferential surface B2S of the cylindrical member B2 of the base B.

(1-2. Method of Adding Shaped Object)

Next, a method of adding a shaped object will be described. Here, as described in the background art, in the LMD method, when adding a hard shaped object to a base, there are problems that sputtering may occur at the time of rapid heating and cracking may occur at the time of rapid solidification, and that accuracy of the shaped object is lowered.

In the present disclosure, since respective laser outputs and respective laser beam profiles of power density, of the central light beam LC and the outer-side light beam LS, are separately controlled, occurrence of sputtering and cracking is suppressed. Specifically, as illustrated in FIG. 2B, the shaped object FF is added to the circumferential surface B2S of the cylindrical member B2 of the base B.

In the method of adding the shaped object FF, as a first stage, initial preheat processing is performed as pre-processing in addition processing of the shaped object FF by using the outer-side light beam LS. At this time, the addition processing of the shaped object FF according to the present disclosure is processing in a second stage. In a state where the circumferential surface B2S of the base B has a low temperature, thermal energy from laser irradiation easily escape to the base B, which is likely to be a cause of a failure of melting in the addition processing of the shaped object FF performed in the second stage, and thus the circumferential surface B2S of the base B is preheated in the first stage. At this time, the laser outputs of the central light beam LC and the outer-side light beam LS in the initial preheat processing are controlled so that the circumferential surface B2S of the base B reaches a predetermined temperature without being melted.

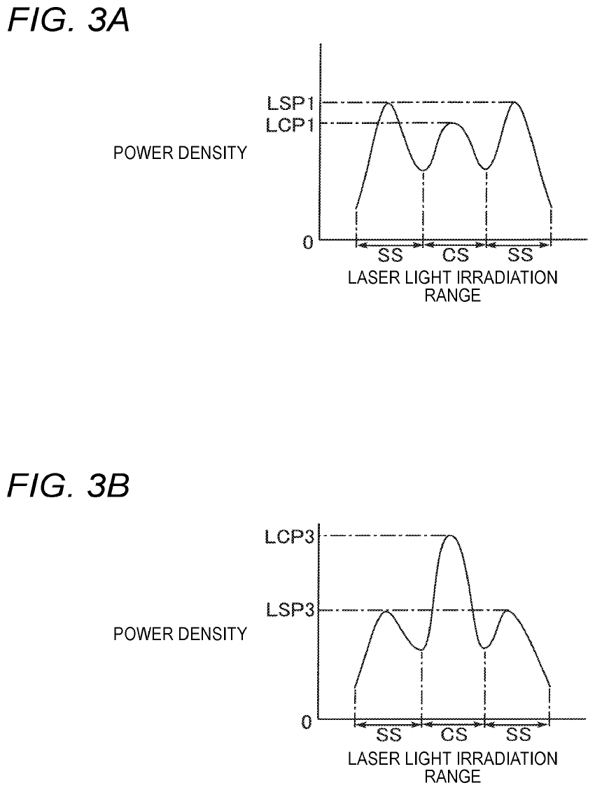

That is, in the first stage, the control unit 130 does not perform supply of the first powder material P1, and performs control to make a peak LCP1 in a laser beam profile of power density of the central light beam LC smaller than a peak LSP1 in a laser beam profile of power density of the outer-side light beam LS as illustrated in a power density graph of FIG. 3A while monitoring measured temperatures of the central light irradiation range CS of the central light beam LC and the outer-side light irradiation range SS of the outer-side light beam LS from a temperature measurement instrument (not illustrated).

The reason why the peak LCP1 of power density of the central light beam LC is reduced to be smaller than the peak LSP1 of power density of the outer-side light beam LS is that heat generated by the central light beam LC is likely to accumulate since the central light beam LC is surrounded by the outer-side light beam LS, and heat generated by the outer-side light beam LS is likely to escape to the outside. As described above, since a power density of the central light beam LC is low, it is possible to suppress occurrence of sputtering due to excessive heat input of the central light beam LC. In addition, since it is possible to input a large amount of energy as the entire laser output while suppressing the peak LCP1, it is possible to efficiently perform preheating while suppressing the occurrence of sputtering.

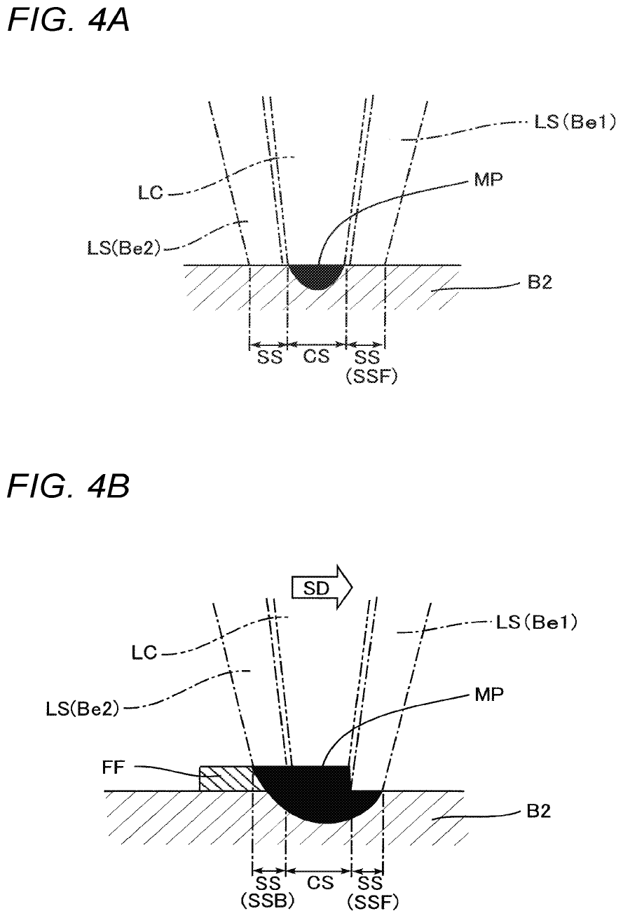

Next, as a second stage, as illustrated in FIG. 4A, melting processing (corresponding to first melting processing) is performed in which the circumferential surface B2S of the base B and the first powder material P1 are melted to form a molten pool MP (corresponding to a first molten pool) in the central light irradiation range CS by irradiation with the central light beam LC. At this time, in an irradiation range SSF on a front side in the scanning direction SD (see FIG. 4B) of the outer-side light irradiation range SS of the outer-side light beam LS, preheat processing (corresponding to first preheat processing) is performed at the same time as pre-processing of formation processing (corresponding to first formation processing) of the molten pool MP with a first light beam Be1 that is a part of the outer-side light beam LS.

Then, as illustrated in FIG. 4B, the molten pool MP is enlarged by performing scanning with the central light beam LC in the scanning direction SD (scanning direction SD) (in this example, the base B is scanned while being rotated. But in FIG. 4B, for convenience, it is illustrated that the central light beam LC is moved in scanning), and the shaped object FF made of the first powder material P1 is added to the base B.

At this time, at the same time, the preheat processing as the pre-processing of the formation processing of the molten pool MP is performed with the first light beam Be1 (outer-side light beam LS) in the irradiation range SSF on the front side in the scanning direction SD of the outer-side light irradiation range SS of the outer-side light beam LS, and temperature-maintaining processing (corresponding to first temperature-maintaining processing) as post-processing of the addition processing of the shaped object FF is performed with a second light beam Be2 as a part of the outer-side light beam LS in an irradiation range SSB on a rear side in the scanning direction SD of the outer-side light irradiation range SS of the outer-side light beam LS.

At this time, the control unit 130 performs control to make a peak LCP3 in the laser beam profile of power density of the central light beam LC larger than a peak LSP3 in the laser beam profile of power density of the outer-side light beam LS, as illustrated in FIG. 3B. The laser output of the central light beam LC is controlled to a temperature at which the first powder material P1 can be melted to form the molten pool MP. Further, the laser output of the outer-side light beam LS (the first light beam Be1 and the second light beam Be2) is controlled so that the first powder material P1 and the shaped object FF reach a predetermined temperature without being melted.

As described above, in the irradiation range SSF on the front side in the scanning direction SD of the outer-side light irradiation range SS of the outer-side light beam LS, the preheat processing is performed as the pre-processing of the formation processing of the molten pool MP with the first light beam Be1 (outer-side light beam LS), whereby the circumferential surface B2S of the base B is brought into a high-temperature state. Therefore, it is not necessary to greatly increase the peak LCP3 in the laser beam profile of power density of the central light beam LC.

Accordingly, rapid heating of the circumferential surface B2S by the central light beam LC can be reduced, and the occurrence of sputtering can be suppressed. In addition, in the irradiation range SSB on the rear side in the scanning direction SD of the outer-side light irradiation range SS of the outer-side light beam LS, the temperature-maintaining processing is performed as the post-processing of the formation processing of the molten pool MP with the second light beam Be2, whereby rapid solidification of the shaped object FF can be suppressed and occurrence of cracking can be prevented.

(1-3. Operation of Additive Manufacturing Device)

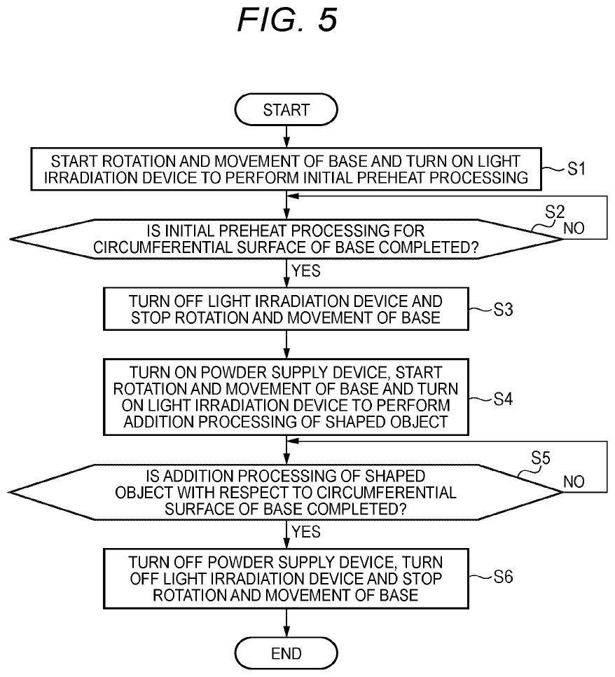

Next, an operation of adding the shaped object FF to the circumferential surface B2S of one cylindrical member B2 of the base B by the additive manufacturing device 100 will be described with reference to a flowchart of FIG. 5. It is assumed that the first powder material P1 mixed with the binding powder material is stored in the first hopper 111.

One end of the circumferential surface B2S of the one cylindrical member B2 of the base B is positioned at a predetermined addition position of the additive manufacturing device 100. In addition, the control unit 130 stores, in advance, the laser outputs and the peaks LCP3 and LSP3 of the laser beam profiles of power density, of the central light beam LC and the outer-side light beam LS in the first and second stages described above, the supply amount of the first powder material P1, data of rotation speed and movement speed of the base B, and the like.

First, the control unit 130 turns on the light irradiation unit 120 at the same time as starting rotation and movement of the base B in order to execute the above-described first stage (initial preheat processing for the circumferential surface B2S of the base B) (step S1 in FIG. 5). Specifically, the control unit 130 drives the motors M1 and M2 to rotate the base B about the central axis C and move the base B in the direction of the central axis C (the other end direction of the circumferential surface B2S).

At the same time, the control unit 130 turns on the central light beam light source 122 to irradiate the circumferential surface B2S of the base B with the central light beam LC from the central light beam irradiation part 121, turns on the outer-side light beam light source 124 to irradiate the circumferential surface B2S of the base B with the outer-side light beam LS from the outer-side light beam irradiation part 123, and executes the initial preheat processing on the circumferential surface B2S of the base B.

Then, the control unit 130 determines whether the initial preheat processing is completed for the circumferential surface B2S of the base B (step S2 in FIG. 5), and when the initial preheat processing is completed, the control unit 130 turns off the light irradiation unit 120 and returns the base B to a start position of the first stage, and stops the rotation and movement of the base B (step S3 in FIG. 5).

Next, in order to execute the above-described second stage (addition processing of the shaped object FF), the control unit 130 turns on the additive material supply unit 110, and turns on the light irradiation unit 120 at the same time as starting the rotation and movement of the base B (step S4 in FIG. 5). Specifically, the control unit 130 opens the gas introduction valve 113d and the powder supply valve 113c, and injects and supplies the first powder material P1 from the injection nozzle 115 to the circumferential surface B2S of the base B by high-pressure nitrogen from the gas cylinder 114. Further, the control unit 130 turns on the central light beam light source 122 to irradiate the circumferential surface B2S of the base B with the central light beam LC from the central light beam irradiation part 121, and turns on the outer-side light beam light source 124 to irradiate the circumferential surface B2S of the base B with the outer-side light beam LS from the outer-side light beam irradiation part 123.

Then, the control unit 130 drives the motors M1 and M2 to rotate the base B about the central axis C and move the base B in the direction of the central axis C (the other end direction of the circumferential surface B2S). At this time, as described above, the preheat processing as the pre-processing for the formation processing of the molten pool MP is performed with the outer-side light beam LS (the first light beam Be1) with which the irradiation range SSF on the front side in the scanning direction SD of the outer-side light beam LS is irradiated. At the same time, the temperature-maintaining processing as the post-processing for the addition processing of the shaped object FF is performed with the outer-side light beam LS (the second light beam Be2) with which the irradiation range SSB on the rear side in the scanning direction SD of the outer-side light beam LS is irradiated.

Accordingly, in the central light irradiation range CS that is irradiated with the central light beam LC after being irradiated with the first light beam Be1, the molten pool MP can be favorably formed sequentially in accordance with the scanning in the scanning direction SD in a state where the preheat processing is performed. Further, in the outer-side light irradiation range SS that is irradiated with the second light beam Be2 (outer-side light beam LS), the temperature of the formed molten pool MP is sequentially and favorably maintained in accordance with the scanning in the scanning direction SD. Accordingly, the shaped object FF without sputtering and cracking is formed.

Then, the control unit 130 determines whether the addition processing of the shaped object FF added to the circumferential surface B2S of the base B is completed (step S5 in FIG. 5). Then, when the addition processing of the shaped object FF is completed, the additive material supply unit 110 and the light irradiation unit 120 are turned off and the rotation and movement of the base B is stopped (step S6 in FIG. 5), bringing all the processing to an end.

(1-4. Effects of First Embodiment)

According to the first embodiment, the additive manufacturing device 100 is a device that adds a shaped object to the base B using a powder material. The additive manufacturing device 100 includes the additive material supply unit 110 that injects and supplies the first powder material P1 to the base B, the light irradiation unit 120 that irradiates a supply portion (circumferential surface B2S) of the first powder material P1 in the base B with a light beam, and a control unit 130 that controls the supply of the first powder material P1 of the additive material supply unit 110 and the light irradiation of the light irradiation unit 120 and controls the relative scanning performed with the light beam with respect to the base B.

The light irradiation unit 120 includes the central light beam irradiation part 121 that irradiates a center of the supply portion (circumferential surface B2S) of the first powder material P1 with the central light beam LC, and the outer-side light beam irradiation part 123 that irradiates an outer side of the central light beam LC with the outer-side light beam LS. Then, the control unit 130 adds the shaped object FF by increasing the peak LCP3 in the beam profile of power density of the central light beam LC to be larger than the peak LSP3 in the beam profile of power density of the outer-side light beam LS by separately controlling the output condition of the central light beam irradiation part 121 and the output condition of the outer-side light beam irradiation part 123.

As described above, since the preheat processing (first preheat processing) as the pre-processing of the addition processing of the shaped object FF can be performed with the first light beam Be1 (outer-side light beam LS), it is not necessary to increase the peak LCP3 in the laser beam profile of power density of the central light beam LC. Accordingly, rapid heating of the circumferential surface B2S of the base B due to the irradiation with the central light beam LC can be reduced, and the occurrence of sputtering can be suppressed. In addition, since the temperature-maintaining processing as the post-processing of the addition processing of the shaped object FF can be performed with the second light beam Be2 (outer-side light beam LS), rapid solidification of the shaped object FF can be suppressed, and the occurrence of cracking can be prevented. Accordingly, a high-quality shaped object FF can be added to the base B.

In addition, according to the first embodiment, the control unit 130 performs scanning with the central light beam LC and the outer-side light beam LS in the same scanning direction SD, and performs the formation processing (first formation processing) of the molten pool MP (first molten pool) and the melting processing (first melting processing) of the first powder material P1 in the central light irradiation range CS of the base B with the central light beam LC. The control unit 130 performs the preheat processing (first preheat processing) as the pre-processing for the formation processing of the molten pool MP with the first light beam Be1 on the front side in the scanning direction SD of the outer-side light beam LS, and performs the temperature-maintaining processing (first temperature-maintaining processing) as the post-processing for the formation processing of the molten pool MP with the second light beam Be2 on the rear side in the scanning direction SD of the outer-side light beam LS.

As described above, since the preheat processing for forming the molten pool MP can be simultaneously performed by one time of scanning with the light beam in the scanning direction SD, rapid heating can be efficiently reduced, and the occurrence of sputtering can be suppressed. At the same time, in the irradiation range SSB on the rear side in the scanning direction SD of the outer-side light irradiation range SS of the outer-side light beam LS, temperature-maintaining processing is performed as the post-processing of the formation processing of the molten pool MP. Also in this case, since the temperature-maintaining processing of the molten pool MP can be performed by one time of scanning with the light beam, rapid solidification of the shaped object FF can be efficiently suppressed, and the occurrence of cracking can be prevented.

### 2. Second Embodiment

(2-1. Outline of Additive Manufacturing Device 200)

Next, an outline of an additive manufacturing device 200 (see FIG. 1) according to a second embodiment will be described. The additive manufacturing device 200 of the second embodiment is different from the additive manufacturing device 100 of the first embodiment in the methods of the preheat processing and the temperature-maintaining processing performed on the circumferential surface B2S of the base B, and the other parts thereof are similar to each other. Therefore, only different parts will be described in detail, and a description of the similar parts will be omitted. The same components are denoted by the same reference signs.

As illustrated in FIG. 1, the additive manufacturing device 200 of the second embodiment includes the additive material supply unit 110, the light irradiation unit 120, a control unit 230, and the like. Similarly to the first embodiment, the additive manufacturing device 200 adds a shaped object to the circumferential surfaces (support portions of bearings (not illustrated)) B2S and B2S indicated by mesh lines on an open end side of the cylindrical members B2 and B2 in the base B having a shape in which the small-diameter cylindrical members B2 and B2 are coaxially integrated with both side surfaces of the large-diameter disk member B1 illustrated in FIG. 2A.

The control unit 230 controls powder supply of the additive material supply unit 110 and light irradiation of the light irradiation unit 120, and controls relative scanning performed with the central light beam LC and the outer-side light beam LS with respect to the circumferential surface B2S of the cylindrical member B2 of the base B. The details will be described later. In the present embodiment, as in the first embodiment, initial preheat processing in a first stage is also performed, but a detailed description thereof will be omitted.

(2-2. Method of Adding Shaped Object)

Next, a method of adding a shaped object will be described. Specifically, similarly to the first embodiment, as illustrated in FIG. 2B, the shaped object FF of a single-layer structure is added to the circumferential surface B2S of the cylindrical member B2 of the base B. In the method of adding the shaped object FF according to the present embodiment, in a second stage, the control unit 230 performs scanning with the central light beam LC and the outer-side light beam LS by a predetermined distance L1 in the same direction in a circumferential direction of the circumferential surface B2S, for a plurality of times, and the shaped object FF is added. At this time, one time of scanning is scanning directed around the central axis C of the cylindrical member B2 on the circumferential surface B2S, and a plurality of times of scanning means that the scanning is performed a plurality of times while moving in the direction of the central axis C of the cylindrical member B2.

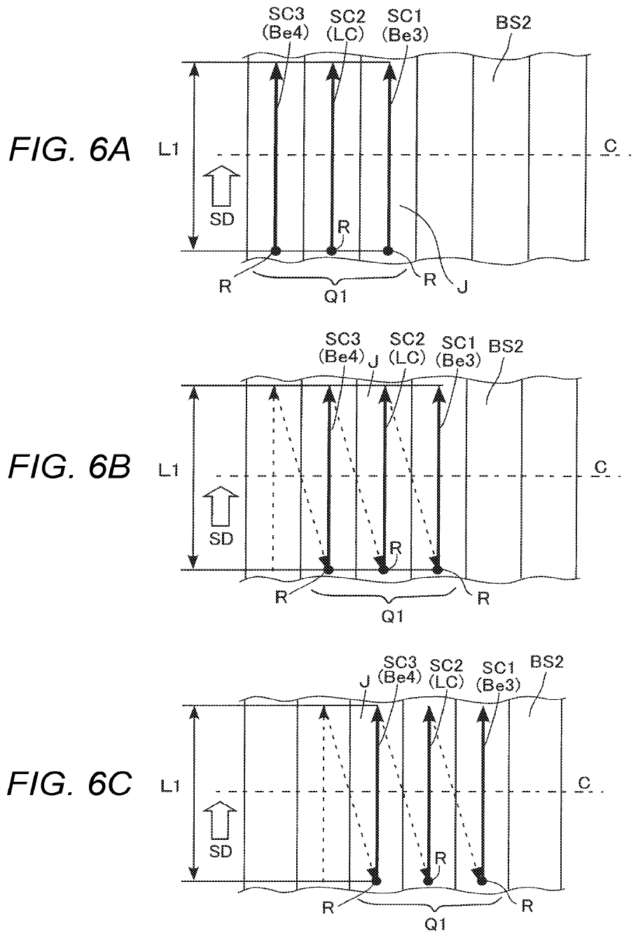

This will be described in detail below. In the description, scanning SC1 to scanning SC3 are defined. As illustrated in FIGS. 6A to 6C in which the circumferential surface B2S is developed in the circumferential direction, in one scanning set Q1 of the light beam corresponding to one time of scanning, scanning located at the center in the direction of the central axis C is defined as second scanning SC2. The second scanning SC2 is scanning performed with the central light beam LC. Further, scanning performed with the outer-side light beam LS (corresponding to a third light beam Be3) on one side (right side in FIG. 6A) of the left and right sides in a scanning direction of the central light beam LC is defined as first scanning SC1. Further, scanning performed with the outer-side light beam (corresponding to a fourth light beam Be4) on the other side (left side in FIG. 6A) of the left and right sides in the scanning direction of the central light beam LC is defined as third scanning SC3.

Formation processing (corresponding to second formation processing) of the molten pool MP (corresponding to a second molten pool) in the central light irradiation range CS of the base B and melting processing (corresponding to second melting processing) of the first powder material P1 are performed with the second scanning SC2 of the central light beam LC. Preheat processing (corresponding to second preheat processing) as pre-processing for the formation processing of forming the molten pool MP (portion J in FIG. 6A) is performed with the first scanning SC1 of the third light beam Be3 (the outer-side light beam LS on one side). Further, temperature-maintaining processing (corresponding to a second temperature-maintaining processing) as post-processing for the formation processing of the molten pool MP (portion K in FIG. 6A) is performed with the third scanning SC3 of the fourth light beam Be4 (the outer-side light beam LS on the other side).

That is, by performing scanning simultaneously with the central light beam LC and the outer-side light beam LS (the third light beam Be3 and the fourth light beam Be4) in the same direction by the predetermined distance L1, the second scanning SC2 (the second formation processing of the second molten pool MP), the first scanning SC1 (the second preheat processing), and the third scanning SC3 (the second temperature-maintaining processing) are simultaneously processed (see Q1 in FIGS. 6A, 6B, and 6C). At this time, when viewed with reference to the second scanning SC2 performed with the central light beam LC, the scanning is performed with the central light beam LC and the outer-side light beam LS (the third light beam Be3 and the fourth light beam Be4) a plurality of times in the same direction by the predetermined distance L1 such that the second scanning SC2 of FIG. 6B to be performed next time with the central light beam LC is adjacent, on one side, to the second scanning SC2 performed this time with the central light beam LC illustrated in FIG. 6A (right side in FIGS. 6A and 6B).

In the above description, when adding the shaped object FF onto the circumferential surface B2S, the control unit 230 controls the peak LCP3 in the laser beam profile of power density of the central light beam LC to be larger than the peak LSP3 in the laser beam profile of power density of the outer-side light beam LS as illustrated in FIG. 3B. At this time, as described above, a laser output of the central light beam LC is controlled to a temperature at which the circumferential surface B2S and the first powder material P1 can be melted to form the molten pool NIP. Further, a laser output of the outer-side light beam LS is controlled so that the first powder material P1 and the circumferential surface B2S of the base reach a predetermined temperature without being melted.

Then, as described above, the scanning performed in the circumferential direction of the circumferential surface B2S by the predetermined distance L1 is repeated a plurality of times toward one side (the right side in FIG. 6A) in the direction of the central axis C of the circumferential surface B2S, thereby adding a part of the shaped object FF to the circumferential surface B2S. At this time, the scanning direction SD (scanning direction) of the central light beam LC and the outer-side light beam LS of this time and the scanning direction SD of the central light beam LC and the outer-side light beam LS of the next time are the same as described above. That is, a position of a start point R is always on the same side in each scanning.

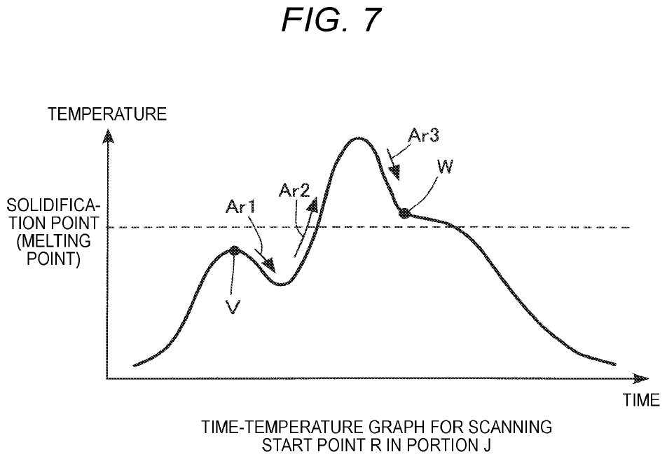

Here, a temperature change of the portion J in FIGS. 6A to 6C will be described. A temperature of the portion J changes as illustrated in a graph of FIG. 7. FIG. 7 is a graph illustrating a temperature change at the start point R of the portion J in the scanning SC1, scanning SC2, and scanning SC3 when the horizontal axis represents time and the vertical axis represents temperature. In FIG. 6A, the portion J is a portion where the preheat processing is performed. In FIG. 6B, the portion J is a portion where the formation processing of the molten pool MP is performed. In FIG. 6C, the portion J is a portion where the molten pool MP is subjected to the temperature-maintaining processing.

As can be seen from FIG. 7, in the preheat processing, by the start of the first scanning SC1, the start point R portion of the first scanning SC1 by the third light beam Be3 (outer-side light beam LS) on the circumferential surface B2S is heated (see V in FIG. 7). At this time, a temperature at V is controlled so as not to exceed a melting point (solidification point) of the circumferential surface B2S of the base B. Thereafter, since the first scanning SC1 performed with the third light beam Be3 is performed by the predetermined distance L1 in a direction away from the start point R, the temperature at the start point R decreases (see an arrow Ar1 in FIG. 7).

Thereafter, in the portion J, the second scanning SC2 performed with the central light beam LC is started from the scanning start point R. Accordingly, the temperature of the portion J increases again (see an arrow Ar2 in FIG. 7) and exceeds the solidification point (melting point), and the circumferential surface B2S is melted to form the molten pool MP (second molten pool). At this time, since heating of the portion J by the central light beam LC is started based on a state where the portion J is preheated by the first scanning SC1, the circumferential surface B2S can be stably melted without being rapidly heated, and occurrence of sputtering is favorably suppressed.

Thereafter, the second scanning SC2 performed with the central light beam LC goes away from the start point R due to being performed by the predetermined distance L1 in the direction away from the start point, and thus the temperature at the start point R decreases (see an arrow Ar3 in FIG. 7). However, at this time, before a temperature of molten metal forming the molten pool MP becomes equal to or lower than the solidification point, the third scanning SC3 performed with the fourth light beam Be4 (outer-side light beam LS) that is next scanning, by which the temperature-maintaining processing is performed, is started from the scanning start point R in the portion J. For this reason, a temperature decrease gradient of the molten metal that started to be rapidly cooled becomes gentle from a position of a point W in FIG. 7 where the temperature-maintaining processing is started, and thereafter, the molten metal is solidified since the temperature thereof falls below the solidification point, and the shaped object FF is formed. As described above, since the shaped object FF is formed not by rapid cooling but by gentle cooling, occurrence of cracking is favorably suppressed.

That is, in the present embodiment, the predetermined distance L1 for performing the scanning SC1, scanning SC2, and scanning SC3 is set such that the third scanning SC3 performed with the fourth light beam Be4 (outer-side light beam LS) is started from the scanning start point R in the portion J before the temperature of the molten metal forming the molten pool MP becomes equal to or lower than the solidification point. In the present embodiment, the predetermined distance L1 is equal to or less than a circumferential length around the central axis C on the circumferential surface B2S of the cylindrical member B2. At this time, it is preferable that the predetermined distance L1 is equal to the circumferential length of the circumferential surface B2S or a length obtained by equally dividing the circumferential length. Accordingly, on the circumferential surface B2S, by performing scanning once in the circumferential direction on the circumferential surface B2S, or by performing scanning an integer number of times after addition of a part of the shaped object FF in the direction of the central axis C is completed, it is possible to add the shaped object FF without sputtering and cracking to the entire circumference in the circumferential direction of the circumferential surface B2S.

(2-3. Effects of Second Embodiment)

According to the second embodiment, the control unit 230 performs scanning with the central light beam LC and the outer-side light beam LS in the same direction by the predetermined distance L1. That is, the formation processing (second formation processing) of the molten pool MP (second molten pool) and the melting processing (second melting processing) of the first powder material P1, in the central light irradiation range CS of the base B, are performed with the central light beam LC in the second scanning SC2. In addition, the preheat processing (second preheat processing) as the pre-processing for the formation processing of the molten pool MP is performed with the third light beam Be3 in the first scanning SC1. Further, the temperature-maintaining processing (second temperature-maintaining processing) as the post-processing for the formation processing of the molten pool MP is performed with the fourth light beam Be4 in the third scanning SC3. Thereafter, the scanning is performed with the central light beam LC and the outer-side light beam LS by the predetermined distance L1 in the same direction so that the second scanning SC2 to be performed next time with the central light beam LC is adjacent, on one side, to the second scanning SC2 performed this time.

Accordingly, for example, the temperature change of the portion J in FIG. 6A is as illustrated in FIG. 7. That is, in the irradiation range SSF on one side in the scanning direction SD in the outer-side light irradiation range SS of the outer-side light beam LS, by performing the preheat processing as the pre-processing of the formation processing of the molten pool MP, the circumferential surface B2S of the base B is brought into a high-temperature state. Therefore, it is not necessary to greatly increase the peak LCP3 in the laser beam profile of power density of the central light beam LC.

Therefore, rapid heating by the central light beam LC can be reduced, and the occurrence of sputtering can be suppressed. In addition, in the irradiation range SSB on the other side in the scanning direction SD in the outer-side light irradiation range SS of the outer-side light beam LS, by performing the temperature-maintaining processing as the post-processing for the formation processing of the molten pool MP, rapid solidification of the shaped object FF can be suppressed, and the occurrence of cracking can be prevented.

According to the second embodiment, the scanning direction SD of the central light beam LC and the outer-side light beam LS in scanning performed this time is the same as the scanning direction SD of the central light beam LC and the outer-side light beam LS in scanning to be performed next time. Accordingly, since the temperature maintaining can be started with a position of the lowest temperature among temperatures of the molten metal in the molten pool MP serving as the start point R, rapid solidification of the shaped object FF can be suppressed, and the occurrence of cracking can be prevented.

In addition, according to the second embodiment, since the temperature maintaining can be started in a state where the temperature of the molten pool MP is reliably at the predetermined temperature or higher, rapid solidification of the shaped object FF can be suppressed, and the occurrence of cracking can be prevented. According to the second embodiment, the predetermined temperature is a solidification temperature of the molten metal melted in the molten pool MP. Accordingly, the predetermined distance L1 can also be easily set according to the solidification temperature of the molten metal melted in the molten pool MP.

In the additive manufacturing device 200 according to the second embodiment, an aspect is described in which the preheat processing is performed by the first scanning SC1 using the third light beam Be3 (the outer-side light beam LS on one side) and the temperature-maintaining processing is performed by the third scanning SC3 using the fourth light beam Be4 (the outer-side light beam LS on the other side). However, actually, the outer-side light beam LS is formed in a ring shape. Therefore, the first light beam Be1 (front side) and the second light beam Be2 (rear side) in the first embodiment also contribute to the preheat processing and the temperature-maintaining processing. In this case, since the scanning with the central light beam LC and the outer-side light beam LS may be controlled with further lower energy, the efficiency thereof is good.

However, the present invention is not limited to this aspect, and when it is desired to eliminate the influence of the first light beam Be1 (front side) and the second light beam Be2 (rear side), the light irradiation unit may be configured such that the outer-side light beam LS is not ring-shaped and the third light beam Be3 and the fourth light beam Be4 can be separately radiated. Also in this case, sufficient effects can be obtained.

### 3. Third Embodiment

(3-1. Outline of Additive Manufacturing Device 300)

Next, an outline of an additive manufacturing device according to a third embodiment of the present disclosure will be described. Note that in addition to the first powder material P1, a powder material (hereinafter, referred to as a binding powder material) such as nickel (Ni) and cobalt (Co), which serves as a binder for a powder material of carbon steel (S45C) (hereinafter, referred to as a second powder material) and the first powder material, is also used in the additive manufacturing, and details will be described later.

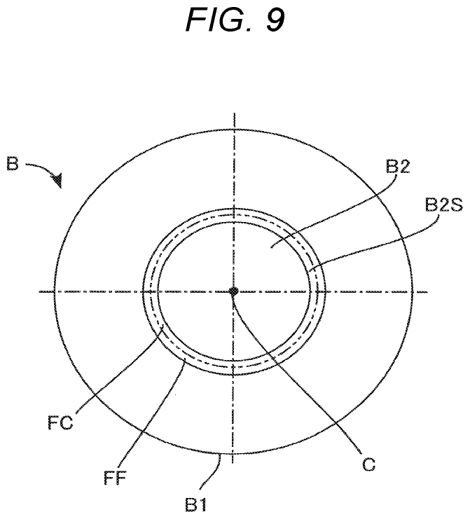

The additive manufacturing device 300 is different from the additive manufacturing devices 100 and 200 of the first and second embodiments in that the shaped object to be added by the additive manufacturing device 300 has a two-layer structure of an intermediate shaped object FC and a shaped object FF (see FIG. 9). The additive manufacturing device 300 adds the shaped object to the base B using one or a plurality of kinds of powder materials by the LMD method. At this time, the powder material and the base B may be different kinds of materials or may be the same kind of material. Hereinafter, parts different from those of the first embodiment will be mainly described in detail, and a description of the similar parts will be omitted. In addition, in the case of the same configuration, the same reference signs may be assigned and illustrated in the drawings.

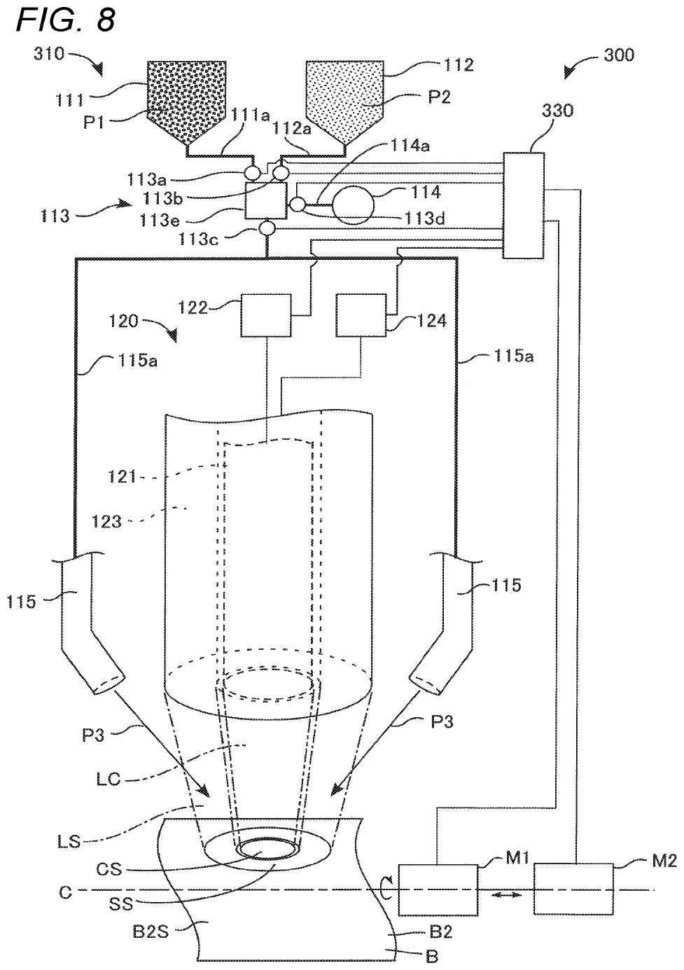

In this example, similarly to the first embodiment, a case where a shaped object made of a powder material of tungsten carbide (WC) (hereinafter, referred to as a first powder material) is added to the base B made of carbon steel (S45C) will be described. As illustrated in FIG. 8, the additive manufacturing device 300 includes an additive material supply unit 310, the light irradiation unit 120, a control unit 330, and the like.

At the time of additive manufacturing, the additive manufacturing device 300 rotates the base B about the central axis C by the motor M1 and moves the base B in the direction of central axis C by the motor M2. Accordingly, the shaped object can be added to the entire circumferential surfaces B2S and B2S on the open end side of the cylindrical members B2 and B2. The shaped object has a two-layer structure of the intermediate shaped object FC and the shaped object FF (see FIG. 9), and details will be described later.

The additive material supply unit 310 includes the first hopper 111, a second hopper 112, a component ratio adjustment unit 113, the gas cylinder 114, and the injection nozzle 115. The first hopper 111 and the second hopper 112 store the first powder material P1 mixed with the binding powder material and a second powder material P2 mixed with the binding powder material, respectively. In this example, since the shaped object FF is made of a large amount of the first powder material P1 and a small amount of the binding powder material, the amount of the binding powder material mixed with the first powder material P1 is set to an amount corresponding to the amount of the binding powder material in the shaped object FF.

In addition, since the intermediate shaped object FC is made of a material in which the amounts of the binding powder material and the second powder material P2 decrease and the amount of the first powder material P1 increases as a thickness thereof increases, the amount of the binding powder material mixed with the second powder material P2 is set to an amount corresponding to the amount of the first powder material P1 in the intermediate shaped object FC. Note that a hopper capable of storing only one kind or three or more kinds of powder materials may be provided.

The component ratio adjustment unit 113 adjusts a component ratio of the first powder material P1 mixed with the binding powder material and from the first hopper 111 and the second powder material P2 mixed with the binding powder material and from the second hopper 112. The component ratio adjustment unit 113 includes a powder agitator 113e to which powder introduction valves 113a and 113b, the powder supply valve 113c, and the gas introduction valve 113d are connected.

The powder introduction valves 113a and 113b are connected to the first hopper 111 and the second hopper 112 by pipes 111a and 112a, respectively, the powder supply valve 113c is connected to the injection nozzle 115 by the pipe 115a, and the gas introduction valve 113d is connected to the gas cylinder 114 by the pipe 114a.

The injection nozzle 115 injects and supplies a powder material (hereinafter, referred to as a third powder material) P3, which has an adjusted component ratio and is sent from the component ratio adjustment unit 113, to the circumferential surface B2S of the cylindrical member B2 of the base B by, for example, high-pressure nitrogen supplied from the gas cylinder 114. Since the light irradiation unit 120 has the same configuration as that of the light irradiation unit 120 of the first embodiment, a description thereof will be omitted.

The control unit 330 controls powder supply of the additive material supply unit 310 and light irradiation of the light irradiation unit 120, and controls relative scanning performed with the central light beam LC and the outer-side light beam LS with respect to the circumferential surface B2S of the cylindrical member B2 of the base B. That is, the control unit 330 controls rotation of the powder introduction valves 113a and 113b to adjust the component ratio of the first powder material P1 mixed with the binding powder material and the second powder material P2 mixed with the binding powder material, and controls opening and closing of the powder supply valve 113c and the gas introduction valve 113d to control injection and supply of the third powder material P3 from the injection nozzle 115.

Further, the control unit 330 controls operations of the central light beam light source 122 and the outer-side light beam light source 124, respectively, and separately controls respective output conditions of the central light beam LC and the outer-side light beam LS, that is, respective laser outputs of the central light beam LC and the outer-side light beam LS and distribution shapes (laser beam profiles) of the laser outputs (power densities) per unit area of the central light irradiation range CS and the outer-side light irradiation range SS.

Further, the control unit 330 controls rotation of the motor M1 to rotate the base B about the central axis C, and controls rotation of the motor M2 to move the base B in a direction of the central axis C, thereby controlling the relative scanning performed with the central light beam LC and the outer-side light beam LS with respect to the circumferential surface B2S of the cylindrical member B2 of the base B.

(3-2. Method of Adding Shaped Object)

Next, a method of adding a shaped object will be described. As illustrated in FIG. 9, on the circumferential surface B2S of the cylindrical member B2 of the base B, the shaped object having a two-layer structure is added, that is, the intermediate shaped object FC is added to a surface of the cylindrical member B2 of the base B, and the shaped object FF is added to a surface of the intermediate shaped object FC. The intermediate shaped object FC is added such that the component ratio of the first powder material P1 mixed with the binding powder material and the second powder material P2 mixed with the binding powder material varies stepwise (is gradually changed).

Specifically, the intermediate shaped object FC is a so-called graded layer in which, from a portion closest to the circumferential surface B2S of the base B in a thickness direction (radial direction) to a portion farthest from the circumferential surface B2S of the base B, the second powder material P2 mixed with the binding powder material decreases linearly (stepwise) from 100% to 0% and the first powder material P1 mixed with the binding powder material increases linearly (stepwise) from 0% to 100%. The shaped object FF is a layer in which the first powder material P1 mixed with the binding powder material is 100% and the second powder material P2 mixed with the binding powder material is 0%.

A portion of the intermediate shaped object FC close to the circumferential surface B2S of the base B contains a large amount of the second powder material P2 (carbon steel (S45C)). Therefore, a difference in thermal expansion coefficient between the circumferential surface B2S (carbon steel (S45C)) of the base B and the intermediate shaped object FC gradually decreases toward a boundary between the circumferential surface B2S of the base B and the intermediate shaped object FC. On the other hand, a portion of the intermediate shaped object FC close to the shaped object FF contains a large amount of the first powder material (tungsten carbide (WC)). Therefore, a difference in thermal expansion coefficient between the intermediate shaped object FC and the shaped object FF (tungsten carbide (WC)) gradually decreases toward a boundary between the intermediate shaped object FC and the shaped object FF.

Therefore, by adding the intermediate shaped object FC to the base B and adding the shaped object FF to the intermediate shaped object FC, occurrence of cracking due to the difference in thermal expansion coefficient can be significantly suppressed. In the method of adding the intermediate shaped object FC and the shaped object FF, as a first stage, initial preheat processing is performed as pre-processing of addition processing of the intermediate shaped object FC, which is to be performed in a second stage, by using the central light beam LC and the outer-side light beam LS. In a state where a temperature of the circumferential surface B2S of the base B is low, thermal energy from laser irradiation easily escapes to the base B, which is likely to be a cause of a failure of melting to be performed in the second stage, and thus the circumferential surface B2S of the base B is preheated in the first stage. The laser outputs of the central light beam LC and the outer-side light beam LS at this time are controlled so that the circumferential surface B2S of the base B reaches a predetermined temperature without being melted.

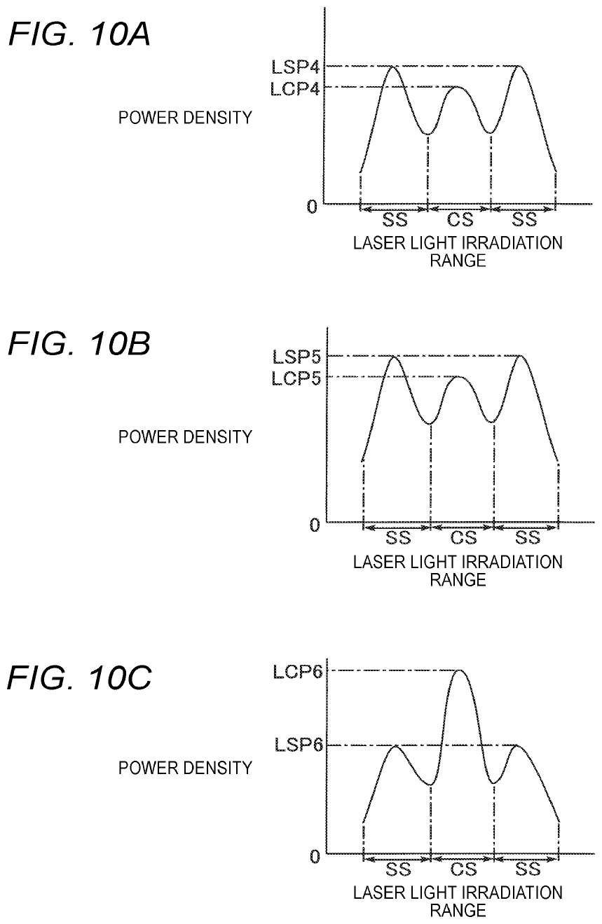

That is, the control unit 330 does not perform supply of the third powder material P3 in the first stage, and performs control to reduce a peak LCP4 in a laser beam profile of power density of the central light beam LC to be smaller than a peak LSP4 in a laser beam profile of power density of the outer-side light beam LS as illustrated in FIG. 10A while monitoring measured temperatures of the central light irradiation range CS of the central light beam LC and the outer-side light irradiation range SS of the outer-side light beam LS from a temperature measurement instrument (not illustrated).

The reason why the peak LCP4 of power density of the central light beam LC is reduced to be smaller than the peak LSP4 of power density of the outer-side light beam LS is the same as the reason described in the first embodiment. Since a power density of the central light beam LC is low, it is possible to suppress occurrence of sputtering due to excessive heat input of the central light beam LC. In addition, since it is possible to input a large amount of energy as the entire laser output while suppressing the peak LCP4, it is possible to efficiently perform preheating while suppressing the occurrence of sputtering.

Next, as the second stage, the first powder material P1 is not melted, and the second powder material P2 is melted to add the intermediate shaped object FC. That is, the control unit 330 monitors the measured temperatures of the central light irradiation range CS of the central light beam LC and the outer-side light irradiation range SS of the outer-side light beam LS from a temperature measurement instrument (not illustrated) while supplying the third powder material P3 having the adjusted component ratio described above. By this monitoring, a peak LCP5 in the laser beam profile of power density of the central light beam LC is controlled to be smaller than a peak LSP5 in the laser beam profile of power density of the outer-side light beam LS, as illustrated in FIG. 10B.

The peaks LCP5 and LSP5 of the central light beam LC and the outer-side light beam LS in the second stage are at values larger than those of the peaks LCP4 and LSP4 of the central light beam LC and the outer-side light beam LS in the first stage because the second powder material P2 needs to be melted. Further, since the component ratio changes as a thickness of the intermediate shaped object FC increases, the control unit 330 performs feedback control to change the laser outputs of the central light beam LC and the outer-side light beam LS while monitoring the measured temperatures of the central light irradiation range CS of the central light beam LC and the outer-side light irradiation range SS of the outer-side light beam LS by a temperature measurement instrument (not illustrated). A relationship between the temperature and the laser output, due to the difference in the component ratio, is constructed in advance as a database.

Also in the second stage, for the same reason as in the first stage, the peak LCP5 of the power density of the central light beam LC is reduced to be smaller than the peak LSP5 of the power density of the outer-side light beam LS. Since a power density of the central light beam LC is low, it is possible to suppress occurrence of sputtering due to excessive heat input of the central light beam LC. In addition, since it is possible to input a large amount of energy as the entire laser output while suppressing the peak LCP5, it is possible to add the intermediate shaped object FC at a high speed while suppressing the occurrence of sputtering.

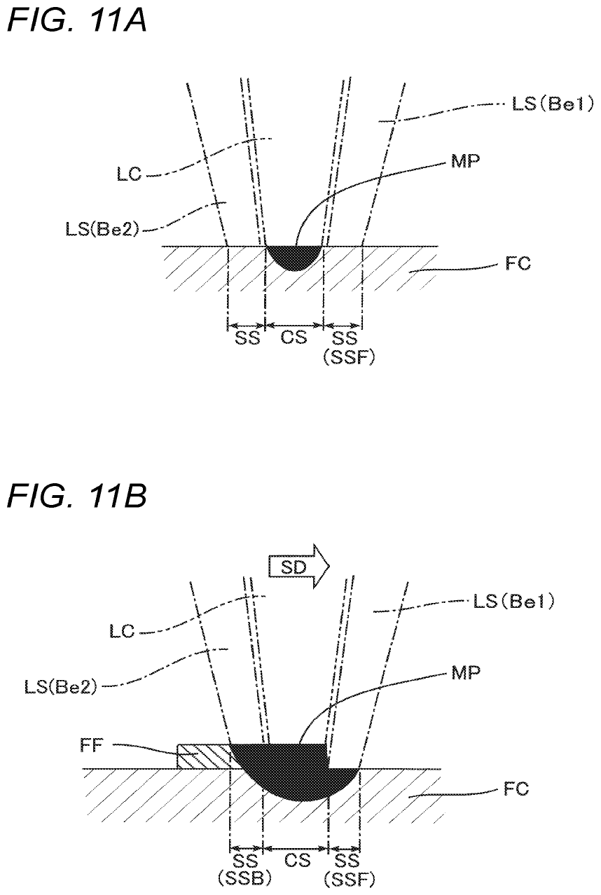

Next, as a third stage, in the central light irradiation range CS of the intermediate shaped object FC, melting processing is performed by irradiation with the central light beam LC, in which the intermediate shaped object FC and the third powder material P3 (actually, only the first powder material mixed with the binding powder material) are melted to form the molten pool MP (see FIG. 11A). At the same time, in the irradiation range SSF on the front side in the scanning direction SD in the outer-side light irradiation range SS of the outer-side light beam LS (see FIG. 11B) with respect to the central light irradiation range CS, the preheat processing as the pre-processing for the formation processing of the molten pool MP is performed.

Then, as illustrated in FIG. 11B, the molten pool MP is enlarged by scanning with the central light beam LC, and the shaped object FF made of the third powder material P3 (actually, only the first powder material mixed with the binding powder material) is added to the intermediate shaped object FC.

At the same time, in the irradiation range SSF on the front side in the scanning direction SD in the outer-side light irradiation range SS of the outer-side light beam LS, the preheat processing is performed as the pre-processing of the formation processing of the molten pool MP, and in the irradiation range SSB on the rear side in the scanning direction SD in the outer-side light irradiation range SS of the outer-side light beam LS, temperature-maintaining processing is performed as post-processing of the addition processing of the shaped object FF.

That is, the control unit 330 performs control to increase a peak LCP6 in the laser beam profile of power density of the central light beam LC to be larger than a peak LSP6 in the laser beam profile of power density of the outer-side light beam LS, as illustrated in FIG. 10C. The laser output of the central light beam LC is controlled to a temperature at which the third powder material P3 (the first powder material P1 mixed with the binding powder material) can be melted to form the molten pool MP. The laser output of the outer-side light beam LS is controlled so that the third powder material P3 (the first powder material mixed with the binding powder material) and the shaped object FF reach a predetermined temperature without being melted.

As described above, in the irradiation range SSF on the front side in the scanning direction SD in the outer-side light irradiation range SS of the outer-side light beam LS, by performing the preheat processing as the pre-processing of the formation processing of the molten pool MP, the intermediate shaped object FC is brought into a high-temperature state, and thus it is not necessary to greatly increase the peak LCP6 in the laser beam profile of power density of the central light beam LC.

Therefore, rapid heating by the central light beam LC can be reduced, and the occurrence of sputtering can be suppressed. In addition, in the irradiation range SSB on the rear side in the scanning direction SD in the outer-side light irradiation range SS of the outer-side light beam LS, by performing the temperature-maintaining processing as the post-processing of the formation processing of the molten pool MP, rapid solidification of the shaped object FF can be suppressed, and the occurrence of cracking can be prevented.

(3-3. Operation of Additive Manufacturing Device)

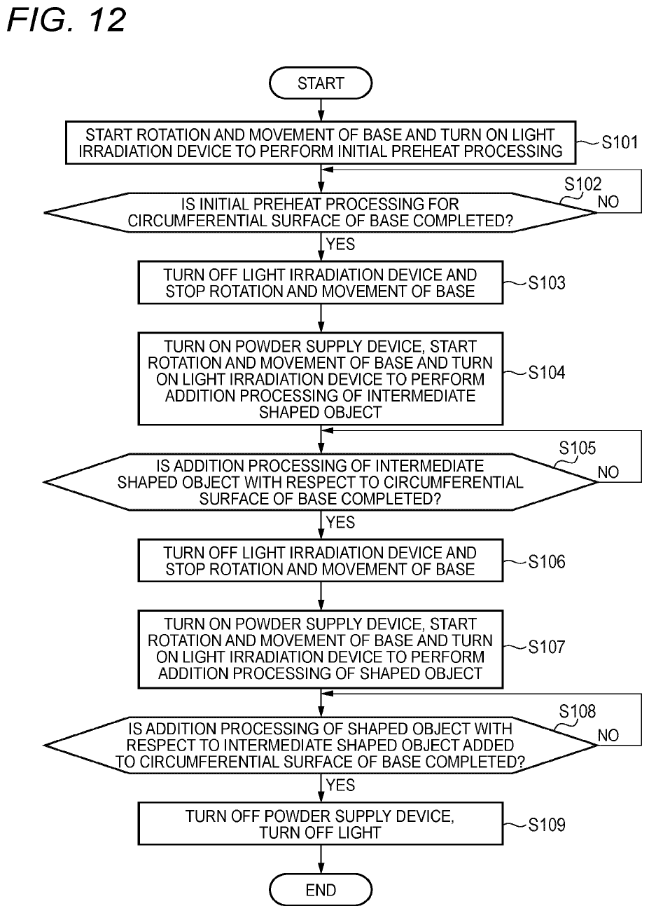

Next, an operation of adding the intermediate shaped object FC and the shaped object FF to the circumferential surface B2S of one cylindrical member B2 of the base B by the additive manufacturing device 300 will be described with reference to a flowchart of FIG. 12. In the control unit 330, data such as the laser outputs and the peaks of the laser beam profiles of power density of the central light beam LC and the outer-side light beam LS in the first, second, and third stages, supply amounts of the first powder material P1 to the third powder material P3, and a rotation speed and a movement speed of the base B is stored in advance.

First, the control unit 330 turns on the light irradiation unit 120 at the same time as starting rotation and movement of the base B in order to execute the above-described first stage (preheat processing for the circumferential surface B2S of the base B) (step S101 in FIG. 12). Specifically, the control unit 330 drives the motors M1 and M2 to rotate the base B about the central axis C and move the base B in the direction of the central axis C (the other end direction of the circumferential surface B2S).

At the same time, the control unit 330 turns on the central light beam light source 122 to irradiate the circumferential surface B2S of the base B with the central light beam LC from the central light beam irradiation part 121, turns on the outer-side light beam light source 124 to irradiate the circumferential surface B2S of the base B with the outer-side light beam LS from the outer-side light beam irradiation part 123, and executes the initial preheat processing on the circumferential surface B2S of the base B.

Then, the control unit 330 determines whether the initial preheat processing is completed for the circumferential surface B2S of the base B (step S102), and when the initial preheat processing is completed, the control unit 330 turns off the light irradiation unit 120 and returns the base B to a start position of the first stage, and stops the rotation and movement of the base B (step S103) Next, in order to execute the above-described second stage (addition processing of the intermediate shaped object FC), the control unit 330 turns on the additive material supply unit 310, and turns on the light irradiation unit 120 at the same time as starting the rotation and movement of the base B (step S104).

Specifically, the control unit 330 appropriately opens and closes the powder introduction valves 113a and 113b of the component ratio adjustment unit 113 to adjust the component ratio of the first powder material P1 and the second powder material P2 to obtain the third powder material P3. Then, the gas introduction valve 113d and the powder supply valve 113c are opened, and the third powder material P3 is injected and supplied from the injection nozzle 115 to the circumferential surface B2S of the base B by high-pressure nitrogen from the gas cylinder 114.

Then, the control unit 330 drives the motors M1 and M2 to rotate the base B about the central axis C and move the base B in the direction of the central axis C (the other end direction of the circumferential surface B2S). At the same time, the central light beam light source 122 is turned on to irradiate the circumferential surface B2S of the base B with the central light beam LC from the central light beam irradiation part 121, and the outer-side light beam light source 124 is turned on to irradiate the circumferential surface B2S of the base B with the outer-side light beam LS from the outer-side light beam irradiation part 123, and the addition processing of the intermediate shaped object FC is executed.

Then, the control unit 330 determines whether the addition processing of the intermediate shaped object FC with respect to the circumferential surface B2S of the base B is completed (step S105), and when the addition processing of the intermediate shaped object FC is completed, the control unit 330 turns off the light irradiation unit 120 and returns the base B to a start position of the second stage, and stops the rotation and movement of the base B (step S106).

Next, in order to execute the above-described third stage (addition processing of the shaped object FF), the control unit 330 turns on the additive material supply unit 310, and turns on the light irradiation unit 120 at the same time as starting the rotation and movement of the base B (step S107). Specifically, the control unit 330 appropriately opens and closes the powder introduction valve 113a while closing the powder introduction valve 113b of the component ratio adjustment unit 113 to obtain only the first powder material P1 as the third powder material P3. Then, the gas introduction valve 113d and the powder supply valve 113c are opened, and the third powder material P3 is injected and supplied from the injection nozzle 115 to the circumferential surface B2S of the base B by high-pressure nitrogen from the gas cylinder 114.

Then, the control unit 330 drives the motors M1 and M2 to rotate the base B about the central axis C and move the base B in the direction of the central axis C (the other end direction of the circumferential surface B2S). At the same time, the central light beam light source 122 is turned on to irradiate the circumferential surface B2S of the base B with the central light beam LC from the central light beam irradiation part 121, and the outer-side light beam light source 124 is turned on to irradiate the circumferential surface B2S of the base B with the outer-side light beam LS from the outer-side light beam irradiation part 123, and the addition processing of the shaped object FF is executed.

Then, the control unit 330 determines whether the addition processing of the shaped object FF with respect to the intermediate shaped object FC added to the circumferential surface B2S of the base B is completed (step S108), and when the addition processing the shaped object FF is completed, the control unit 330 turns off the additive material supply unit 310 and the light irradiation unit 120, stops the rotation and movement of the base B (step S109), and ends the whole processing.

(3-4. Effects of Third Embodiment)

According to the third embodiment, the additive material supply unit 310 includes the component ratio adjustment unit 113 that adjusts the component ratio of a plurality of kinds of powder materials. Accordingly, it is possible to easily form the intermediate shaped object FC as a graded layer in which components are adjusted in the radial direction.

According to the additive manufacturing device 300 of the third embodiment, the additive manufacturing device 300 includes: the additive material supply unit 310 that includes the component ratio adjustment unit 113, which adjusts the component ratio of the plurality of kinds of powder materials, and that injects and supplies the powder material having an adjusted component ratio to the base B; the light irradiation unit 120 that irradiates a supply portion of the powder material having the adjusted component ratio in the base B with a light beam; and the control unit 330 that controls the powder supply of the additive material supply unit 310 and the light irradiation of the light irradiation unit 120 and controls the relative scanning performed with the light beam with respect to the base B.

The light irradiation unit 120 includes the central light beam irradiation part 121 that irradiates a center of the supply portion of the powder material having the adjusted component ratio with the central light beam LC as a light beam, and the outer-side light beam irradiation part 123 that irradiates an outer side of the central light beam LC with the outer-side light beam LS as a light beam. Then, the control unit 330 performs control to add the intermediate shaped object FC, in which the component ratio gradually changes in the thickness direction, to the surface of the base B, and controls an output condition of the central light beam irradiation part 121 and an output condition of the outer-side light beam irradiation part 123 separately according to the change in the component ratio in forming the intermediate shaped object FC.

With such a configuration, the difference in thermal expansion coefficient between the circumferential surface B2S (carbon steel (S45C)) of the base B and the intermediate shaped object FC can be formed to gradually decrease toward the boundary between the circumferential surface B2S of the base B and the intermediate shaped object FC. The portion of the intermediate shaped object FC close to the shaped object FF can contain a large amount of the first powder material (tungsten carbide (WC)). Therefore, the difference in thermal expansion coefficient between the intermediate shaped object FC and the shaped object FF (tungsten carbide (WC)) can be gradually reduced toward the boundary between the intermediate shaped object FC and the shaped object FF. Thus, by adding the intermediate shaped object FC to the base B and adding the shaped object FF to the intermediate shaped object FC, the occurrence of cracking due to the difference in thermal expansion coefficient can be significantly suppressed.

In addition, according to the third embodiment, when adding the intermediate shaped object FC, the control unit 330 increases the peak LSP5 in the beam profile of power density of the outer-side light beam LS to be larger than the peak LCP5 in the beam profile of power density of the central light beam LC. As described above, at the time of adding the intermediate shaped object FC, the power density of the central light beam LC is low, and thus it is possible to suppress the occurrence of sputtering due to excessive heat input of the central light beam LC. In addition, since it is possible to input a large amount of energy as the entire laser output while suppressing the peak LCP5, it is possible to add the intermediate shaped object FC at a high speed while suppressing the occurrence of sputtering.

In addition, according to the third embodiment, when adding the shaped object FF (upper shaped object), the control unit 330 increases the peak LCP6 in the beam profile of power density of the central light beam LC to be larger than the peak LSP6 in the beam profile of power density of the outer-side light beam LS, performs the formation processing of the molten pool MP of the base B and the melting processing of the powder material having an adjusted component ratio in the central light irradiation range CS with the central light beam LC, performs the preheat processing as the pre-processing for the formation processing of the molten pool MP on the front side in the scanning direction of the outer-side light beam LS, and performs the temperature-maintaining processing as the post-processing for the formation processing of the molten pool MP on the rear side in the scanning direction of the outer-side light beam LS. Accordingly, in the scanning direction of the outer-side light beam LS and the central light beam LC, the preheat processing, the formation of the molten pool MP, and the temperature-maintaining processing for the molten pool MP can be easily and efficiently performed.

### 4. Fourth Embodiment

(4-1. Outline of Additive Manufacturing Device)

An outline of an additive manufacturing device 1000 according to a fourth embodiment of the present disclosure will be described. The additive manufacturing device adds a shaped object to a base using one or a plurality of kinds of powder materials by the LMD method. The powder material and the base may be different kinds of materials, or may be the same kind of material.

In the fourth embodiment, a case where a shaped object made of a powder material of copper (Cu) (hereinafter, referred to as a first powder material) is added to the base B made of iron (Fe) will be described. In the additive manufacturing, a powder material of iron (Fe) or nickel (Ni) (hereinafter, referred to as a second powder material) serving as a binder for the first powder material is also used, and details will be described later.

As illustrated in FIG. 8, the additive manufacturing device 1000 includes a powder supply unit 1110 (additive material supply unit), the light irradiation unit 120, a control unit 1130, and the like. The additive manufacturing device 1000 is different from the additive manufacturing devices 100 and 200 of the first and second embodiments in that the shaped object to be added by the additive manufacturing device 1000 has a two-layer structure of the intermediate shaped object FC and the shaped object FF (see FIG. 9).

In the additive manufacturing, the additive manufacturing device 1000 rotates the base B about the central axis C by the motor M1 (see FIG. 8) and moves the base B in the direction of central axis C by the motor M2 (see FIG. 8). Accordingly, the shaped object can be added to the entire circumferential surfaces B2S and B2S on the open end side of the cylindrical members B2 and B2.

The powder supply unit 1110 includes the first hopper 111, the second hopper 112, the component ratio adjustment unit 113, the gas cylinder 114, and the injection nozzle 115. The first hopper 111 and the second hopper 112 store a first powder material P101 and a second powder material P102, respectively. Note that a hopper capable of storing only one kind or three or more kinds of powder materials may be provided.

The component ratio adjustment unit 113 adjusts a component ratio of the first powder material P101 from the first hopper 111 and the second powder material P102 from the second hopper 112. The component ratio adjustment unit 113 includes the powder agitator 113e to which the powder introduction valves 113a and 113b, the powder supply valve 113c, and the gas introduction valve 113d are connected.

The powder introduction valves 113a and 113b are connected to the first hopper 111 and the second hopper 112 by pipes 111a and 112a, respectively, the powder supply valve 113c is connected to the injection nozzle 115 by the pipe 115a, and the gas introduction valve 113d is connected to the gas cylinder 114 by the pipe 114a.

The injection nozzle 115 injects and supplies a powder material (hereinafter, referred to as a third powder material) P103, which has an adjusted component ratio and is sent from the component ratio adjustment unit 113, to the circumferential surface B2S of the cylindrical member B2 of the base B by, for example, high-pressure nitrogen supplied from the gas cylinder 114. In the fourth embodiment, a case where two injection nozzles 115 are arranged at an interval of 180 degrees is exemplified, and alternatively a configuration may be adopted in which one injection nozzle is provided or three or more injection nozzles arranged at an equal angular interval are provided. The gas for supplying the third powder material P103 is not limited to nitrogen, and may be an inert gas such as argon.

The light irradiation unit 120 includes the central light beam irradiation part 121, the central light beam light source 122, the outer-side light beam irradiation part 123, and the outer-side light beam light source 124. The light irradiation unit 120 irradiates the circumferential surface B2S (supply portion of the third powder material P103) of the cylindrical member B2 of the base B with the central light beam LC from the central light beam light source 122 through the central light beam irradiation part 121, and irradiates the circumferential surface B2S with the outer-side light beam LS from the outer-side light beam light source 124 through the outer-side light beam irradiation part 123.

In the fourth embodiment, the central light beam irradiation part 121 radiates the central light beam LC having a circular irradiation shape (central light irradiation range CS), and the outer-side light beam irradiation part 123 radiates the outer-side light beam LS having a ring-shaped irradiation shape (outer-side light irradiation range SS) surrounding an outer periphery of the central light beam LC. The central light beam LC plays a role in adding the shaped object to the circumferential surface B2S of the cylindrical member B2 of the base B. A role of the outer-side light beam LS will be described later. Although laser light is used as the central light beam LC and the outer-side light beam LS, the central light beam LC and the outer-side light beam LS are not limited to laser light, and may be, for example, electron beams as long as they are electromagnetic waves.

The control unit 1130 controls powder supply of the powder supply unit 1110 and light irradiation of the light irradiation unit 120, and controls relative scanning performed with the central light beam LC and the outer-side light beam LS with respect to the circumferential surface B2S of the cylindrical member B2 of the base B. That is, the control unit 1130 controls rotation of the powder introduction valves 113a and 113b to adjust a component ratio of the first powder material P101 and the second powder material P102, and controls opening and closing of the powder supply valve 113c and the gas introduction valve 113d to control injection and supply of the third powder material P103 from the injection nozzle 115.

Further, the control unit 1130 controls operations of the central light beam light source 122 and the outer-side light beam light source 124, respectively, and separately controls respective output conditions of the central light beam LC and the outer-side light beam LS, that is, respective laser outputs of the central light beam LC and the outer-side light beam LS and distribution shapes (laser beam profiles) of the laser outputs (power densities) per unit area of the central light irradiation range CS and the outer-side light irradiation range SS.

Further, the control unit 1130 controls rotation of the motor M1 to rotate the base B about the central axis C, and controls rotation of the motor M2 to move the base B in the direction of the central axis C, thereby controlling the relative scanning performed with the central light beam LC and the outer-side light beam LS with respect to the circumferential surface B2S of the cylindrical member B2 of the base B.

(4-2. Method of Adding Shaped Object)

Next, a method of adding a shaped object will be described. Here, as described in the background art, in the LMD method, there is a problem that it is difficult to stably add a shaped object to a base in a case where the base and the shaped object have different laser absorbability (light beam absorptance, thermal conductivity).

In the present disclosure, output conditions of the central light beam LC and the outer-side light beam LS, that is, respective laser outputs and respective peaks in the laser beam profiles of power density are separately controlled and adjusted according to light beam absorptance of the powder material. Further, the shaped object is formed so as to have a two-layer structure in a radial direction. Accordingly, even if the laser absorptance of the base is different from that of the shaped object, the shaped object is stably added to the base.

Specifically, when the laser absorptance of the powder material is relatively high (in the fourth embodiment, the second powder material P102 is iron (Fe)), a peak in the beam profile of power density of the central light beam LC is reduced to be smaller than a peak in the beam profile of power density of the outer-side light beam LS. Accordingly, rapid heating of the central light irradiation range CS of the central light beam LC can be prevented, and thus occurrence of sputtering can be suppressed. In addition, since a total laser output of the central light beam LC and the outer-side light beam LS can be maintained, high-speed addition of the shaped object is possible.

When the laser absorptance of the powder material is relatively low (in the fourth embodiment, the first powder material P101 is copper (Cu)), the peak in the beam profile of power density of the central light beam LC is increased to be larger than the peak in the beam profile of power density of the outer-side light beam LS. Accordingly, a temperature of the central light irradiation range CS of the central light beam LC can be increased to form a molten pool, and laser absorptance in the central light irradiation range CS can be improved.

Thereafter, the peak in the beam profile of power density of the central light beam LC is reduced to be smaller than the peak in the beam profile of power density of the outer-side light beam LS. This is because the temperature of the central light irradiation range CS of the central light beam LC is already increased, and further heating may cause sputtering. Accordingly, since the total laser output of the central light beam LC and the outer-side light beam LS can be maintained, high-speed addition of the shaped object is possible.

As illustrated in FIG. 9, on the circumferential surface B2S of the cylindrical member B2 of the base B, the shaped object having a two-layer structure is added, that is, the intermediate shaped object FC is added to a surface of the cylindrical member B2 of the base B, and the upper shaped object FF is added to a surface of the intermediate shaped object FC. The intermediate shaped object FC is added such that a component ratio of the first powder material P101 and the second powder material P102 varies stepwise (is gradually changed).

Specifically, the intermediate shaped object FC is a so-called graded layer in which, from a portion closest to the circumferential surface B2S of the base B in a thickness direction (radial direction) to a portion farthest from the circumferential surface B2S of the base B, the second powder material P102 decreases stepwise or linearly from 100% to 0% and the first powder material P101 increases stepwise or linearly from 0% to 100%. For example, by a process of forming a layer on the circumferential surface B2S of the base B by mixing of 10% of the first powder material P101 and 90% of the second powder material P102, then on this layer, forming another layer by mixing of a changed component ratio of 20% of the first powder material P101 and 80% of the second powder material P102 . . . and finally, forming a layer by mixing of a changed component ratio of 90% of the first powder material P101 and 10% of the second powder material P102, the graded layer is added in a stepwise manner. The upper shaped object FF is a layer containing 100% of the first powder material P101 and 0% of the second powder material P102.

Since the circumferential surface B2S of the base B and the second powder material P102 are of the same material (iron-based material (Fe)), a difference in laser absorptance between the circumferential surface B2S of the base B and the intermediate shaped object FC gradually decreases toward a boundary between the circumferential surface B2S of the base B and the intermediate shaped object FC in the thickness direction. On the other hand, since the upper shaped object FF and the first powder material P101 are of the same material (copper (Cu)), a difference in laser absorptance between the intermediate shaped object FC and the upper shaped object FF gradually decreases toward a boundary between the intermediate shaped object FC and the upper shaped object FF in the thickness direction.

Therefore, the shaped objects FC and FF can be stably added to the base B by adding the intermediate shaped object FC to the base B and adding the upper shaped object FF to the intermediate shaped object FC. In the method of adding the intermediate shaped object FC and the upper shaped object FF, as a first stage, preheat processing is performed as pre-processing of addition processing of the intermediate shaped object FC, which is to be performed in a second stage, by using the central light beam LC and the outer-side light beam LS. The laser outputs of the central light beam LC and the outer-side light beam LS at this time are controlled so that the circumferential surface B2S of the base B reaches a predetermined temperature without being melted.

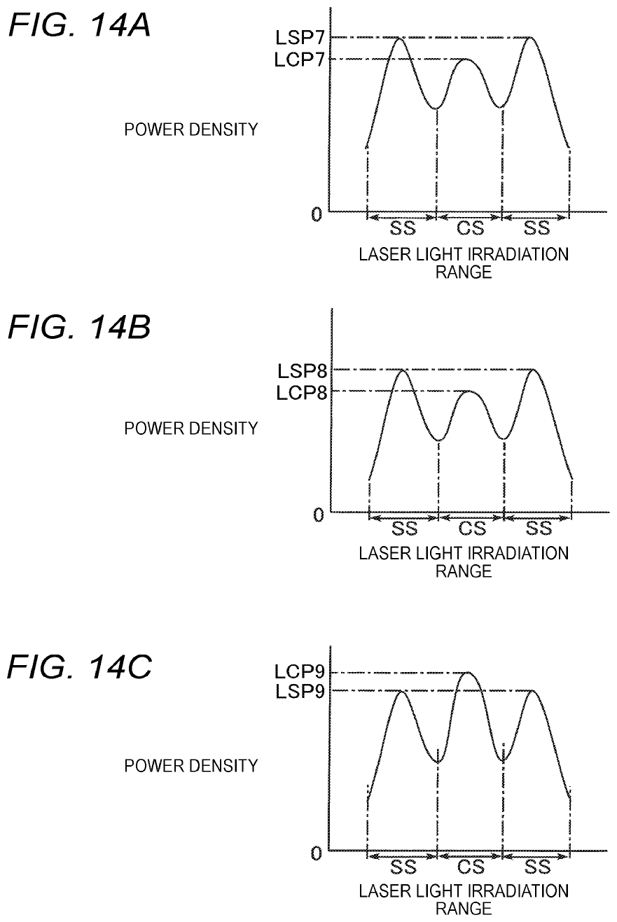

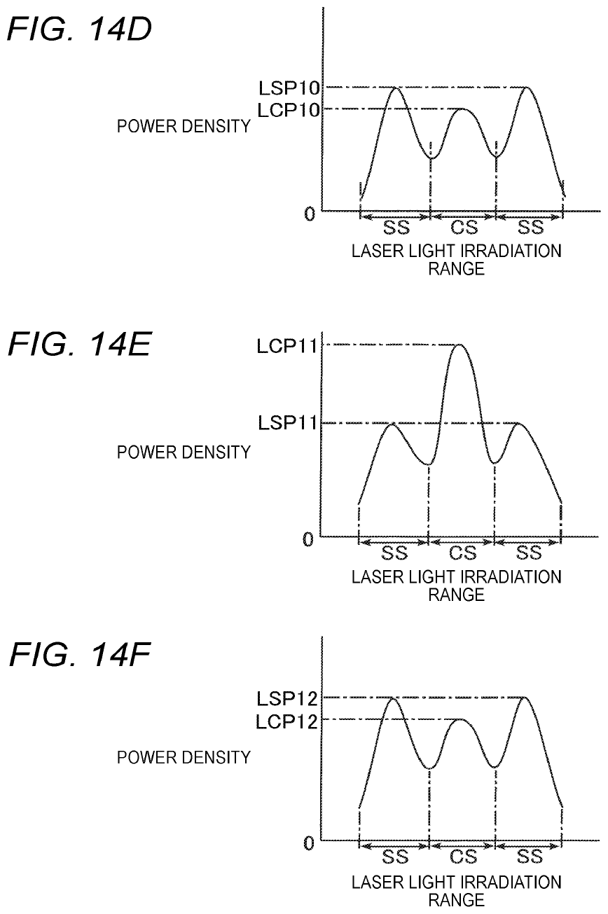

That is, the control unit 1130 does not perform supply of the third powder material P103, and monitors measured temperatures of the central light irradiation range CS of the central light beam LC and the outer-side light irradiation range SS of the outer-side light beam LS from a temperature measurement instrument (not illustrated). By this monitoring, a peak LCP7 in the laser beam profile of power density of the central light beam LC is controlled to be smaller than a peak LSP7 in the laser beam profile of power density of the outer-side light beam LS as illustrated in FIG. 14A.

The reason why the peak LCP7 of power density of the central light beam LC is reduced to be smaller than the peak LSP7 of power density of the outer-side light beam LS is that heat generated by the central light beam LC is likely to accumulate since the central light beam LC is surrounded by the outer-side light beam LS, and heat generated by the outer-side light beam LS is likely to escape to the outside. Since a power density of the central light beam LC is low, it is possible to suppress occurrence of sputtering due to excessive heat input of the central light beam LC.

Next, as a second stage, the first powder material P101 and the second powder material P102 are melted to add the intermediate shaped object FC. That is, the control unit 1130 monitors the measured temperatures of the central light irradiation range CS of the central light beam LC and the outer-side light irradiation range SS of the outer-side light beam LS from a temperature measurement instrument (not illustrated) while supplying the third powder material P103 having the adjusted component ratio described above.

By this monitoring, in an initial phase of the second stage, a peak LCP8 in the laser beam profile of power density of the central light beam LC is controlled to be smaller than a peak LSP8 in the laser beam profile of power density of the outer-side light beam LS as illustrated in FIG. 14B.

In the initial phase of the second stage, the peaks LCP8 and LSP8 of the central light beam LC and the outer-side light beam LS are at values smaller than those of the peaks LCP7 and LSP7 of the central light beam LC and the outer-side light beam LS in the first stage. This is because the circumferential surface B2S of the base B is subjected to the preheat processing, and the second powder material P102 having a relatively high laser absorptance is overwhelmingly more than the first powder material P101 having a relatively low laser absorptance.

In a middle phase of the second stage, a peak LCP9 in the laser beam profile of power density of the central light beam LC is controlled to be larger than a peak LSP9 in the laser beam profile of power density of the outer-side light beam LS as illustrated in FIG. 14C.

In the middle phase of the second stage, the peaks LCP9 and LSP9 of the central light beam LC and the outer-side light beam LS are at values larger than those of the peaks LCP8 and LSP8 of the central light beam LC and the outer-side light beam LS in the initial phase of the second stage. This is because the first powder material P101 having a relatively low laser absorptance is more than the second powder material P102 having a relatively high laser absorptance. Although a case where three peaks LSP9, LCP9, and LSP9 are provided in FIG. 14C is described, only one peak LCP9 of the central light beam LC may be provided therein.

In an end phase of the second stage, a peak LCP10 in the laser beam profile of power density of the central light beam LC is controlled to be smaller than a peak LSP10 in the laser beam profile of power density of the outer-side light beam LS as illustrated in FIG. 14D. This is because a high-temperature state is established by the central light beam LC in the middle phase of the second stage.

In the second stage, the control unit 1130 performs feedback control to change the laser outputs of the central light beam LC and the outer-side light beam LS while monitoring the measured temperatures of the central light irradiation range CS of the central light beam LC and the outer-side light irradiation range SS of the outer-side light beam LS by a temperature measurement instrument (not illustrated). A relationship between the temperature and the laser output, due to the difference in the component ratio, is constructed in advance as a database.

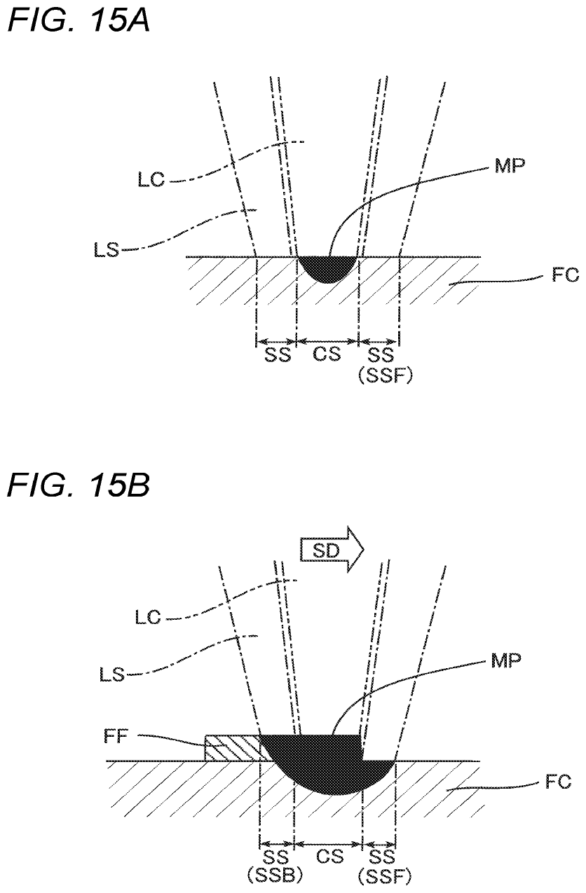

Next, as a third stage, as illustrated in FIG. 15A, melting processing of melting the first powder material P101 in the central light irradiation range CS of the intermediate shaped object FC by the central light beam LC to form the molten pool MP is performed. At the same time, in the irradiation range SSF on the front side in the scanning direction SD (see FIG. 15B) in the outer-side light irradiation range SS of the outer-side light beam LS, the preheat processing is performed as the pre-processing of the formation processing of the molten pool MP.

Then, as illustrated in FIG. 15B, the molten pool MP is enlarged by performing scanning with the central light beam LC (in the fourth embodiment, the base B is scanned while being rotated. But in FIG. 15B, for convenience, it is illustrated that the central light beam LC is moved in scanning), and the upper shaped object FF made of the first powder material P101 is added to the intermediate shaped object FC.

At the same time, in the irradiation range SSF on the front side in the scanning direction SD in the outer-side light irradiation range SS of the outer-side light beam LS, the preheat processing is performed as the pre-processing of the formation processing of the molten pool MP, and in the irradiation range SSB on the rear side in the scanning direction SD in the outer-side light irradiation range SS of the outer-side light beam LS, temperature-maintaining processing is performed as post-processing of the addition processing of the upper shaped object FF.

In an initial phase of the third stage, the control unit 1130 performs control to increase a peak LCP11 in the laser beam profile of power density of the central light beam LC to be larger than a peak LSP11 in the laser beam profile of power density of the outer-side light beam LS as illustrated in FIG. 14E.

The laser output of the central light beam LC is controlled such that a temperature is reached at which the first powder material P101 can be melted to form the molten pool MP. The laser output of the outer-side light beam LS is controlled so that the third powder material P103 (first powder material) and the upper shaped object FF reach a predetermined temperature without being melted. Although a case where three peaks LSP11, LCP11, and LSP11 are provided in FIG. 14E is described, only one peak LCP11 of the central light beam LC may be provided therein.

In an end phase of the third stage, a peak LCP12 in the laser beam profile of power density of the central light beam LC is controlled to be smaller than a peak LSP12 in the laser beam profile of power density of the outer-side light beam LS as illustrated in FIG. 14F. This is because the upper shaped object FF is brought into a high-temperature state by the central light beam LC, and since the temperature and the laser absorptance of the upper shaped object FF are in a proportional relationship, the laser absorptance of the upper shaped object FF is increased.

Therefore, rapid heating by the central light beam LC can be reduced, and the occurrence of sputtering can be suppressed. In addition, in the irradiation range SSB on the rear side in the scanning direction SD in the outer-side light irradiation range SS of the outer-side light beam LS, by performing the temperature-maintaining processing as the post-processing of the formation processing of the molten pool MP, rapid solidification of the upper shaped object FF can be reduced, and occurrence of cracking can be suppressed.

(4-3. Operation of Additive Manufacturing Device)

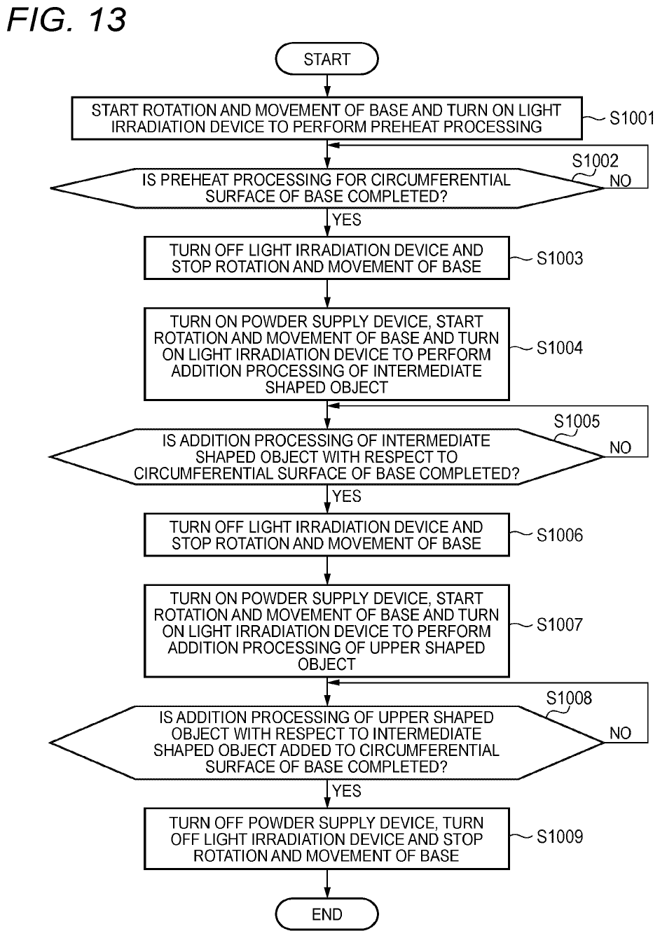

Next, an operation of adding the intermediate shaped object FC and the upper shaped object FF to the circumferential surface B2S of one cylindrical member B2 of the base B by the additive manufacturing device 1000 will be described with reference to a flowchart of FIG. 13. The first powder material P101 and the second powder material P102 are stored in the first hopper 111 and the second hopper 112, respectively.

One end of the circumferential surface B2S of the one cylindrical member B2 of the base B is positioned at a predetermined addition position of the additive manufacturing device 1000. In the control unit 1130, data such as the laser outputs and the peaks of the laser beam profiles of power density of the central light beam LC and the outer-side light beam LS in the first, second, and third stages, supply amounts of the first powder material, second powder material, and third powder material P103, and a rotation speed and a movement speed of the base B is stored in advance.

First, the control unit 1130 turns on the light irradiation unit 120 at the same time as starting rotation and movement of the base B in order to execute the above-described first stage (preheat processing for the circumferential surface B2S of the base B) (step S1001 in FIG. 13). Specifically, the control unit 1130 drives the motors M1 and M2 to rotate the base B about the central axis C and move the base B in the direction of the central axis C (the other end direction of the circumferential surface B2S).

At the same time, the control unit 1130 turns on the central light beam light source 122 to irradiate the circumferential surface B2S of the base B with the central light beam LC from the central light beam irradiation part 121, turns on the outer-side light beam light source 124 to irradiate the circumferential surface B2S of the base B with the outer-side light beam LS from the outer-side light beam irradiation part 123, and executes the preheat processing on the circumferential surface B2S of the base B.

Then, the control unit 1130 determines whether the preheat processing is completed for the circumferential surface B2S of the base B (step S1002 in FIG. 13), and when the preheat processing is completed, the control unit 1130 turns off the light irradiation unit 120 and returns the base B to a start position of the first stage, and stops the rotation and movement of the base B (step S1003 in FIG. 13). Next, in order to execute the above-described second stage (addition processing of the intermediate shaped object FC), the control unit 1130 turns on the powder supply unit 1110, and turns on the light irradiation unit 120 at the same time as starting the rotation and movement of the base B (step S1004 in FIG. 13).

Specifically, the control unit 1130 appropriately opens and closes the powder introduction valves 113a and 113b of the component ratio adjustment unit 113 to adjust a component ratio of the first powder material P101 and the second powder material P102 to obtain the third powder material P103. Then, the gas introduction valve 113d and the powder supply valve 113c are opened, and the third powder material P103 is injected and supplied from the injection nozzle 115 to the circumferential surface B2S of the base B by high-pressure nitrogen from the gas cylinder 114.

Then, the control unit 1130 drives the motors M1 and M2 to rotate the base B about the central axis C and move the base B in the direction of the central axis C (the other end direction of the circumferential surface B2S). At the same time, the central light beam light source 122 is turned on to irradiate the circumferential surface B2S of the base B with the central light beam LC from the central light beam irradiation part 121, and the outer-side light beam light source 124 is turned on to irradiate the circumferential surface B2S of the base B with the outer-side light beam LS from the outer-side light beam irradiation part 123, and the addition processing of the intermediate shaped object FC is executed.

Then, the control unit 1130 determines whether the addition processing of the intermediate shaped object FC with respect to the circumferential surface B2S of the base B is completed (step S1005 in FIG. 13), and when the addition processing of the intermediate shaped object FC is completed, the control unit 1130 turns off the light irradiation unit 120 and returns the base B to a start position of the second stage, and stops the rotation and movement of the base B (step S1006 in FIG. 13).

Next, in order to execute the above-described third stage (addition processing of the upper shaped object FF), the control unit 1130 turns on the powder supply unit 1110, and turns on the light irradiation unit 120 at the same time as starting the rotation and movement of the base B (step S1007 in FIG. 13). Specifically, the control unit 1130 appropriately opens and closes the powder introduction valve 113a while closing the powder introduction valve 113b of the component ratio adjustment unit 113 to obtain only the first powder material P101 as the third powder material P103. Then, the gas introduction valve 113d and the powder supply valve 113c are opened, and the third powder material P103 is injected and supplied from the injection nozzle 115 to the circumferential surface B2S of the base B by high-pressure nitrogen from the gas cylinder 114.

Then, the control unit 1130 drives the motors M1 and M2 to rotate the base B about the central axis C and move the base B in the direction of the central axis C (the other end direction of the circumferential surface B2S). At the same time, the central light beam light source 122 is turned on to irradiate the circumferential surface B2S of the base B with the central light beam LC from the central light beam irradiation part 121, and the outer-side light beam light source 124 is turned on to irradiate the circumferential surface B2S of the base B with the outer-side light beam LS from the outer-side light beam irradiation part 123, and the addition processing of the upper shaped object FF is executed.

Then, the control unit 1130 determines whether the addition processing of the upper shaped object FF with respect to the intermediate shaped object FC added to the circumferential surface B2S of the base B is completed (step S1008 in FIG. 13), and when the addition processing the upper shaped object FF is completed, the control unit 1130 turns off the powder supply unit 1110 and the light irradiation unit 120 and stops the rotation and movement of the base B (step S1009 in FIG. 13) to end the whole processing.

### 5. Others

According to the first, second, third, and fourth embodiments, the outer-side light beam irradiation part 123 radiates a ring-shaped light beam as the outer-side light beam LS. This makes it possible for easily arrangement at equal intervals in front-rear and left-right directions with respect to the central light beam LC, which contributes to cost reduction.

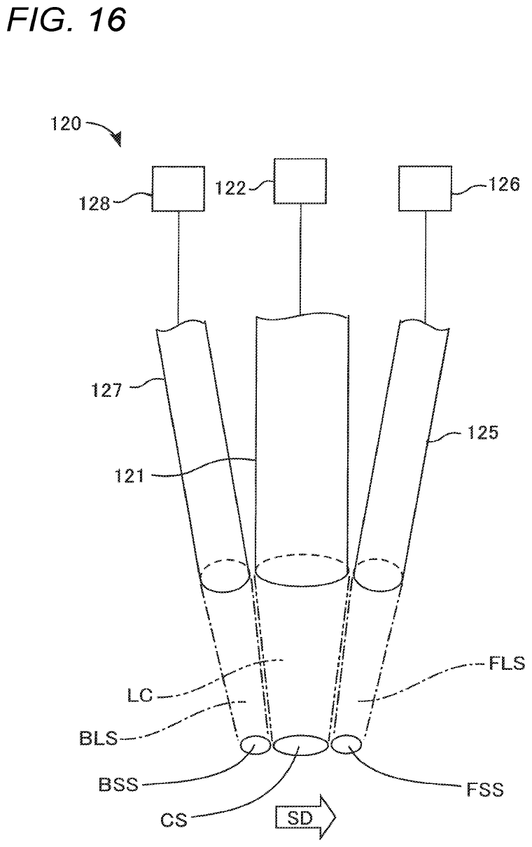

In the first embodiment, the light irradiation unit 120 is configured to include the central light beam irradiation part 121, the central light beam light source 122, the outer-side light beam irradiation part 123, and the outer-side light beam light source 124. However, as illustrated in FIG. 16, the light irradiation unit 120 may be configured to include a front-side light beam irradiation part (outer-side light beam irradiation part) 125, a front-side light beam light source 126, a rear-side light beam irradiation part (outer-side light beam irradiation part) 127, and a rear-side light beam light source 128 in place of the outer-side light beam irradiation part 123 and the outer-side light beam light source 124.

The front-side light beam irradiation part 125 irradiates a front side in the scanning direction SD of the central light beam LC with a front-side light beam FLS (outer-side light beam, first light beam Be1) having a circular irradiation shape (front-side light irradiation range FSS). The rear-side light beam irradiation part 127 irradiates a rear side in the scanning direction SD of the central light beam LC with a rear-side light beam BLS (outer-side light beam, second light beam Be2) having a circular irradiation shape (rear-side light irradiation range BSS). Then, in the front-side light irradiation range FSS of the front-side light beam FLS, the preheat processing is performed as the pre-processing of the formation processing of the molten pool MP, and in the rear-side light irradiation range BSS of the rear-side light beam BLS, the temperature-maintaining processing is performed as the post-processing of the addition processing of the shaped object FF. Also in the second, third, and fourth embodiments, similarly to the above description, an irradiation part that separately radiates a first light beam Be1 to a fourth light beam Be4 may be provided.

Although a case where the shaped object FF is formed of a large amount of the first powder material P1 and a small amount of the binding powder material is described in the first, second, and third embodiments described above, the shaped object FF in a case of being formed of only the first powder material P1 that does not contain the binding powder material can be added, similarly to the first, second, and third embodiments. In addition, when adding a shaped object made of a hard material other than tungsten carbide (WC) to the base B made of a soft material, it is possible to add an intermediate shaped object by adjusting a component ratio of the soft material and the hard material in the same manner as in the third embodiment without containing a binding powder material, and then add the shaped object made of only the hard material without containing the binding powder material, similarly to the third embodiment.

Although a case where the intermediate shaped object FC and the shaped object FF (upper shaped object) added to the base B are made of different kinds of materials is described in the third and fourth embodiments, the present invention can be applied to a case similarly where the intermediate shaped object FC and the shaped object FF are made of the same material. In this case, it is not necessary to add the intermediate shaped object FC. In addition, even when the materials are not the same material but have similar thermal expansion coefficients, the addition of the intermediate shaped object FC is not necessary.

Although the additive material supply units 110 and 310 inject and supply the powder material to the base B in the first, second, and third embodiments described above, the present invention is not limited to this aspect, and the additive material supply unit may supply a linear metal material such as a wire to add the shaped object FF to the base B. Also in this case, effects similar to those of the above-described embodiments can be expected.

The present application is based on Japanese Patent Application No. 2018-228886 filed on Dec. 6, 2018, Japanese Patent Application No. 2018-234110 filed on Dec. 14, 2018, and Japanese Patent Application No. 2019-124359 filed on Jul. 3, 2019, the contents of which are incorporated herein by reference.

1. An additive manufacturing device configured to form a shaped object on a base by using one material of a powdery material and a linear material, the additive manufacturing device comprising:
an additive material supply unit configured to supply the one material to the base;
a light irradiation unit configured to irradiate a supply portion on the base with a light beam, the supply portion being a portion to which the one material is supplied; and
a control unit configured to control a supply of the one material by the additive material supply unit, an irradiation with a light beam by the light irradiation unit, and a relative movement of the light beam to the base,
wherein the light irradiation unit includes a central light beam irradiation part that irradiates a central portion of the supply portion of the one material with a central light beam and an outer-side light beam irradiation part that irradiates an outer side of the central light beam with an outer-side light beam, and the light beam includes the central light beam and the outer-side light beam,
wherein the control unit is configured to separately control an output condition of the central light beam irradiation part and an output condition of the outer-side light beam irradiation part,
wherein the central light beam has a power density related to the output condition of the central light beam irradiation part, and the outer-side light beam has a power density related to the output condition of the outer-side light beam irradiation part, and
wherein the control unit is configured to adjust a peak in a distribution shape of the power density of the central light beam and a peak in a distribution shape of the power density of the outer-side light beam to form the shaped object.

2. The additive manufacturing device according to claim 1,
wherein the control unit is configured to increase the peak in the distribution shape of the power density of the central light beam to be larger than the peak in the distribution shape of the power density of the outer-side light beam to form the shaped object.

3. The additive manufacturing device according to claim 2,
wherein the control unit is configured to:
perform a first formation processing of forming a first molten pool corresponding to a central light irradiation range of the base that is irradiated with the central light beam and a first melting processing of melting the one material;
in a front-rear direction in which the light beam is moved, perform a first preheat processing with a first light beam of the outer-side light beam provided on a front side in the front-rear direction, before the first formation processing of the first molten pool; and
in the front-rear direction in which the light beam is moved, perform a first temperature-maintaining processing with a second light beam of the outer-side light beam provided on a rear side in the front-rear direction, after the first formation processing of the first molten pool.

4. The additive manufacturing device according to claim 2,
wherein the control unit is configured to perform a first control of moving the central light beam and the outer-side light beam by a predetermined distance in the front-rear direction, the outer-side light beam being adjacent to the central light beam on left and right sides with respect to the front-rear direction,
wherein in the first control, the control unit is configured to:
perform a second formation processing of forming a second molten pool corresponding to a central light irradiation range of the base that is irradiated with the central light beam and a second melting processing of melting the one material;
perform a second preheat processing with a third light beam of the outer-side light beam provided on one side of the left and right sides, before the second formation processing of the second molten pool; and
perform a second temperature-maintaining processing with a fourth light beam of the outer-side light beam provided on the other side of the left and right sides, after the second formation processing of the second molten pool, and
wherein the control unit is configured to perform, following the first control, second control of moving the central light beam and the outer-side light beam adjacent to the central light beam on the left and right sides by the predetermined distance in the front-rear direction along a direction in which the third light beam of the outer-side light beam provided on the one side moves in the first control.

5. The additive manufacturing device according to claim 4,
wherein a direction in which the central light beam and the outer-side light beam adjacent to the central light beam on the left and right sides move in the first control is the same as a direction in which the central light beam and the outer-side light beam adjacent to the central light beam on the left and right sides move in the second control.

6. The additive manufacturing device according to claim 4,
wherein the predetermined distance is set such that:
in the predetermined distance, while the second formation processing of forming the second molten pool and the second melting processing of melting the one material are performed with the central light beam in the first control, the second preheat processing is completed with the third light beam and the third light beam is moved on the one side of the base in the first control; and
in the predetermined distance, after the fourth light beam is moved on the other side of the base and the second temperature-maintaining processing is performed with the fourth light beam in the first control, when the fourth light beam is moved to a range in the first control in which the second molten pool is formed with the central light beam, a temperature of a molten metal in the second molten pool is equal to or higher than a predetermined temperature.

7. The additive manufacturing device according to claim 6,
wherein the predetermined temperature is a solidification temperature of the molten metal melted in the second molten pool.

8. The additive manufacturing device according to claim 1,
wherein the powdery material includes a plurality of kinds of powdery materials, and
wherein the additive material supply unit includes a component ratio adjustment unit that adjusts a component ratio of the plurality of kinds of powdery materials.

9. An additive manufacturing device configured to form a shaped object on a base by using a plurality of kinds of powdery materials, the additive manufacturing device comprising:
an additive material supply unit including a component ratio adjustment unit that adjusts a component ratio of the plurality of kinds of powdery materials, and configured to supply an adjusted powdery material to the base in an injection manner, the adjusted powdery material being a material to which the component ratio adjustment unit has adjusted the component ratio;
a light irradiation unit configured to irradiate a supply portion on the base with a light beam, the supply portion being a portion to which the adjusted powdery material is supplied; and
a control unit configured to control a supply of the adjusted powdery material by the additive material supply unit, an irradiation with a light beam by the light irradiation unit, and a relative movement of the light beam to the base,
wherein the light irradiation unit includes a central light beam irradiation part that irradiates a central portion of the supply portion of the adjusted powdery material with a central light beam and an outer-side light beam irradiation part that irradiates an outer side of the central light beam with an outer-side light beam, and the light beam includes the central light beam and the outer-side light beam.

10. The additive manufacturing device according to claim 9,
wherein the control unit is configured to separately control an output condition of the central light beam irradiation part and an output condition of the outer-side light beam irradiation part in accordance with a change in the component ratio, when forming, on a surface of the base, an intermediate shaped object in which the component ratio gradually changes in a thickness direction.

11. The additive manufacturing device according to claim 10,
wherein the central light beam has a power density related to the output condition of the central light beam irradiation part, and the outer-side light beam has a power density related to the output condition of the outer-side light beam irradiation part, and
wherein the control unit is configured to increase a peak in a distribution shape of the power density of the outer-side light beam to be larger than a peak in a distribution shape of the power density of the central light beam, when forming the intermediate shaped object.

12. The additive manufacturing device according to claim 10,
wherein the control unit is configured to increase a peak in a distribution shape of a power density of the central light beam to be larger than a peak in distribution of a power density of the outer-side light beam, when forming the shaped object, and
wherein the control unit is configured to:
perform a formation processing of forming a molten pool corresponding to a central light irradiation range of the base that is irradiated with the central light beam and a melting processing of melting the adjusted powdery material;
in a front-rear direction in which the light beam is moved, perform a preheat processing with the outer-side light beam provided on a front side in the front-rear direction, before the formation processing of the molten pool; and
in the front-rear direction in which the light beam is moved, perform a temperature-maintaining processing with the outer-side light beam provided on a rear side in the front-rear direction, after the formation processing of the molten pool.

13. The additive manufacturing device according to claim 1,
wherein the outer-side light beam radiated from the outer-side light beam irradiation part has a ring shape.

14. The additive manufacturing device according to claim 1,
wherein the control unit is configured to separately control the output condition of the central light beam irradiation part and the output condition of the outer-side light beam irradiation part in accordance with a light beam absorptance of the powdery material.

15. The additive manufacturing device according to claim 14,
wherein the powdery material includes a plurality of kinds of powdery materials, and
wherein the additive material supply unit includes a component ratio adjustment unit that is capable of adjusting a component ratio of the plurality of kinds of powdery materials.

16. The additive manufacturing device according to claim 9,
wherein the control unit is configured to separately control an output condition of the central light beam irradiation part and an output condition of the outer-side light beam irradiation part in accordance with a light beam absorptance of an intermediate shaped object, when forming, on a surface of the base, the intermediate shaped object in which the component ratio gradually changes in a thickness direction,
wherein the central light beam has a power density related to the output condition of the central light beam irradiation part, and the outer-side light beam has a power density related to the output condition of the outer-side light beam irradiation part, and
wherein the control unit is configured to:
adjust a peak in a distribution shape of the power density of the central light beam and a peak in a distribution shape of the power density of the outer-side light beam; and
when forming an upper shaped object having one kind of the powdery material among the plurality of kinds of powdery materials on a surface of the intermediate shaped object, adjust the peak in the distribution shape of the power density of the central light beam and the peak in the distribution shape of the power density of the outer-side light beam by separately controlling the output condition of the central light beam irradiation part and the output condition of the outer-side light beam irradiation part in accordance with a light beam absorptance of the upper shaped object.

17. The additive manufacturing device according to claim 14,
wherein the control unit is configured to:
when the light beam absorptance of the powdery material is relatively high, reduce the peak in the distribution shape of the power density of the central light beam to be smaller than the peak in the distribution shape of the power density of the outer-side light beam; and
when the light beam absorptance of the powdery material is relatively low, increase the peak in the distribution shape of the power density of the central light beam to be larger than the peak in the distribution shape of the power density of the outer-side light beam, and thereafter reduce the peak in the distribution shape of the power density of the central light beam to be smaller than the peak in the distribution shape of the power density of the outer-side light beam.

18. The additive manufacturing device according to claim 14,
wherein the outer-side light beam radiated from the outer-side light beam irradiation part has a ring shape.
